(19) United States
(12) Patent Application Publication
(10) Pub. No.: US 2024/0365312 A1
(43) Pub. Date: Oct. 31, 2024

(54) UPLINK TRANSMISSION WITH MULTIPLE CODEWORDS

(71) Applicant: Telefonaktiebolaget LM Ericsson (publ), Stockholm (SE)

(72) Inventors: Zhipeng Lin, Nanjing (CN); Yufei Blankenship, Kildeer, IL (US); Siva Muruganathan, Stittsville (CA); Shiwei Gao, Nepean (CA)

(21) Appl. No.: 18/682,697

(22) PCT Filed: Aug. 22, 2022
(86) PCT No.: PCT/CN2022/113884

§ 371 Date: Feb. 9, 2024

(30) Foreign Application Priority Data
Aug. 23, 2021 (WO) PCT/CN2021/114080

(51) Int. Cl. H04W 72/1268; H04L 1/00; H04L 5/00; H04W 72/21; H04W 72/231

(52) U.S. Cl. CPC H04W 72/1268; H04L 1/0003; H04L 5/0051; H04W 72/21; H04W 72/231

(57) ABSTRACT

The present disclosure is related to a UE, a network node, and methods for uplink transmission with multiple codewords. The method at a UE for uplink transmission with multiple codewords comprises: performing, with one or more network nodes, an uplink transmission with multiple codewords. The method at a network node for uplink transmission with multiple codewords from a UE comprises: performing, with the UE, an uplink transmission with multiple codewords.

### CROSS-REFERENCE TO RELATED APPLICATION(S)

This application claims priority to the PCT International Application No. PCT/CN2021/114080, entitled “UPLINK TRANSMISSION WITH MULTIPLE CODEWORDS”, filed on Aug. 23, 2021, which is incorporated herein by reference in its entirety.

### TECHNICAL FIELD

The present disclosure is related to the field of telecommunication, and in particular, to a user equipment (UE), a network node, and methods for uplink transmission with multiple codewords.

### BACKGROUND

With the development of the electronic and telecommunications technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels, a 5G communications system is able to manage the data transfers in an orderly fashion and the system is able to understand what data is arriving and hence it is able to process the data in the required fashion. As there are many different types of data that need to be transferred-user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: Is the multiplexing of the logical data to be transported by the physical layer and its channels over the radio interface.
Physical channel: The physical channels are those which are closest to the actual transmission of the data over the radio access network/5G Radio Frequency (RF) signal. They are used to carry the data over the radio interface.

The physical channels often have higher level channels mapped onto them for providing a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a UE and a base station (BS).

There are three physical channels for each of the uplink and downlink: Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

According to a first aspect of the present disclosure, a method at a UE for uplink transmission with multiple codewords is provided. The method comprises: performing, with one or more network nodes, an uplink transmission with multiple codewords.

In some embodiments, before the step of performing the uplink transmission, the method further comprises: transmitting, to at least one of the one or more network nodes, a message indicating whether uplink transmission with multiple codewords is supported by the UE or not. In some embodiments, the message indicates at least one of: —whether configured grant (CG) based uplink transmission with multiple codewords is supported by the UE or not; —whether Type 1 CG based uplink transmission with multiple codewords is supported by the UE or not; —whether Type 2 CG based uplink transmission with multiple codewords is supported by the UE or not; and —whether dynamic grant (DG) based uplink transmission with multiple codewords is supported by the UE or not. In some embodiments, the message only indicates whether DG based uplink transmission with multiple codewords is supported by the UE or not. In some embodiments, after the step of transmitting the message, the method further comprises: receiving, from the at least one network node, a configuration indicating whether a single codeword or multiple codewords shall be used by the UE for its uplink transmission. In some embodiments, the configuration is received via UE-specific Radio Resource Control (RRC) signaling.

In some embodiments, when the uplink transmission is Type 2 CG-based uplink transmission or DG based uplink transmission and before the step of performing the uplink transmission, the method further comprises: receiving, from at least one of the network nodes, at least one Downlink Control Information (DCI) message for scheduling the uplink transmission. In some embodiments, for at least one of the multiple codewords, the DCI message comprises at least one field for at least one of: —a Modulation and Coding Scheme (MCS); —a New Data Indicator (NDI); and —a Redundancy Version (RV). In some embodiments, the DCI message is a DCI message of a legacy DCI format. In some embodiments, the DCI message is a DCI format 0_0, 0_1 or 0_2 message. In some embodiments, the DCI message is not a DCI message of a legacy DCI format. In some embodiments, the step of receiving, from at least one of the network nodes, a DCI message for scheduling the uplink transmission comprises: receiving, from at least one of the network nodes, multiple DCI messages for jointly scheduling the uplink transmission. In some embodiments, the multiple DCI messages comprise at least a first DCI message scheduling one or more parameters for a first of the multiple codewords and a second DCI message scheduling one or more parameters for a second of the multiple codewords.

In some embodiments, when the uplink transmission is Type 1 CG-based uplink transmission and before the step of performing the uplink transmission, the method further comprises: receiving, from at least one of the network nodes, an RRC message scheduling the uplink transmission. In some embodiments, for at least one of the multiple codewords, the RRC message comprises at least one field for at least one of: —an MCS index; —an MCS table; —information for precoding and number of layers; and —a Sounding Reference Signal (SRS) resource indicator (SRI). In some embodiments, the RRC message comprises a ConfiguredGrantConfig information element (IE) that comprises at least one of: —a precodingAndNumberOfLayers2ndTB IE for configuring the information for precoding and number of layers for a codeword; —a srs-ResourceIndicator2ndTB IE for configuring the SRI for the codeword; and —a mcsAndTBS2ndTB IE for configuring modulation order, target code rate, and/or transport block (TB) size for the codeword.

In some embodiments, before the step of performing the uplink transmission, the method further comprises: receiving, from at least one of the network nodes, an RRC message indicating a maximum number of codewords for uplink transmission. In some embodiments, the RRC message comprises at least one of: —a maxNrofCodeWordsScheduledByDCI-0-1 IE in a PUSCH-Config IE indicating a maximum number of codewords for DG based uplink transmission scheduled by a DCI format 0_1 message; —a maxNrofCodeWordsScheduledByDCI-0-2 IE in a PUSCH-Config IE indicating a maximum number of codewords for DG based uplink transmission scheduled by a DCI format 0_2 message; —a maxNrofCodeWords IE in a PUSCH-Config IE indicating a maximum number of codewords for any uplink transmission to the at least one network node; —a maxNrofCodeWordsScheduledByDCI-0-1 IE in a PUSCH-Config IE indicating a maximum number of codewords for DG based uplink transmission and/or Type 2 CG based uplink transmission scheduled by a DCI format 0_1 message; —a maxNrofCodeWordsScheduledByDCI-0-2 IE in a PUSCH-Config IE indicating a maximum number of codewords for DG based uplink transmission and/or Type 2 CG based uplink transmission scheduled by a DCI format 0_2 message; —a maxNrofCodeWordsScheduledByRRC IE in a PUSCH-Config IE indicating a maximum number of codewords for Type 1 CG based uplink transmission schedule by RRC signaling; and —a maxNrofCodeWords IE in a ConfiguredGrantConfig IE indicating a maximum number of codewords for CG based uplink transmission.

In some embodiments, the uplink transmission is targeted towards two or more of the network nodes. In some embodiments, the uplink transmission comprises at least one or more first transmission layers targeted towards a first of the two or more network nodes and one or more second transmission layers targeted towards a second of the two or more network nodes. In some embodiments, at least two of the transmission layers are transmitted over a same time-frequency resource. In some embodiments, all the transmission layers are transmitted over a same time-frequency resource. In some embodiments, for at least two of the two or more network nodes, the uplink transmission comprises a same or different number of transmission layers targeted towards the corresponding network node. In some embodiments, for each of the two or more network nodes, the uplink transmission comprises a same or different number of transmission layers targeted towards the corresponding network node. In some embodiments, the uplink transmission is DG based uplink transmission or Type 2 CG based uplink transmission. In some embodiments, one or more DCI messages that are received by the UE and schedule the uplink transmission comprise, for at least one of the multiple codewords, at least one of: —MCS; —RV; —Transmit Precoding Matrix Indicator (TPMI) and/or a number of transmission layers when the uplink transmission is a codebook based uplink transmission; and —one or more SRIs. In some embodiments, one or more DCI messages that are received by the UE and schedule the uplink transmission comprise, for each of the multiple codewords, at least one of: —MCS; —RV; —TPMI and/or a number of transmission layers when the uplink transmission is a codebook based uplink transmission; and —one or more SRIs. In some embodiments, when the uplink transmission is codebook based uplink transmission, the one or more DCI messages comprise, for at least one of the multiple codewords, a single or no SRI, wherein when the uplink transmission is non-codebook based uplink transmission, the one or more DCI messages comprise, for at least one of the multiple codewords, one or more SRIs. In some embodiments, when the uplink transmission is codebook based uplink transmission, the one or more DCI messages comprise, for each of the multiple codewords, a single or no SRI, wherein when the uplink transmission is non-codebook based uplink transmission, the one or more DCI messages comprise, for each of the multiple codewords, one or more SRIs. In some embodiments, a first SRI configured for a first codeword indicates an SRS resource from a first SRS resource set, wherein a second SRI configured for a second codeword indicates an SRS resource from a second SRS resource set that is different from the first SRS resource set.

In some embodiments, the method further comprises: receiving, from a network node, a message indicating that at least one of the multiple codewords is disabled; and performing, with the network node, another uplink transmission with the at least one codeword disabled. In some embodiments, the message is a DCI message comprising multiple fields, and a combination of specific values of the one or more of the multiple fields indicates that a corresponding codeword is disabled.

In some embodiments, the method further comprises: receiving, from at least one of the network nodes, a message indicating a configuration for Demodulation Reference Signal (DMRS) ports for the multiple codewords. In some embodiments, the message is a DCI message comprising a single antenna port field that indicates the configuration for DMRS ports for the multiple codewords. In some embodiments, the single antenna port field is decoded by at least one of: —referring to one or more first antenna port tables when the transform precoder is disabled and when a number of transmission layers is less than or equal to 4; —referring to one or more second antenna port tables that are different from the one or more first antenna port tables when the transform precoder is disabled and when the number of transmission layers is greater than 4; and —referring to one or more third antenna port tables when the transform precoder is enabled. In some embodiments, the single antenna port field is decoded as follows: —referring to one or more first antenna port tables when the transform precoder is disabled and when a number of transmission layers is less than or equal to 4; —referring to one or more second antenna port tables that are different from the one or more first antenna port tables when the transform precoder is disabled and when the number of transmission layers is greater than 4; and —referring to one or more third antenna port tables when the transform precoder is enabled.

In some embodiments, before the step of performing the uplink transmission, the method further comprises: receiving, from at least one of the network nodes, a DCI message for scheduling the uplink transmission and indicating that no Uplink Shared Channel (UL-SCH) data is to be transmitted in the uplink transmission, wherein the step of performing the uplink transmission comprises: performing the uplink transmission comprising multiple Uplink Control Information (UCI) that are mapped to one or more codewords.

In some embodiments, a first UCI having a first UCI type priority is mapped to a first codeword while a second UCI having a second UCI type priority is mapped to a second codeword that is different from the first codeword, and the second UCI type priority is lower than the first UCI type priority. In some embodiments, each of the multiple UCI has one of multiple UCI type priorities, wherein a first UCI having a first UCI type priority is mapped to a first codeword while a second UCI having a second UCI type priority that is lower than the first UCI type priority is mapped to a second codeword that is different from the first codeword. In some embodiments, UCI type priorities of at least two of following are ordered from high to low in their listed order: Hybrid automatic Repeat Request-Acknowledgement (HARQ-ACK), Scheduling Request (SR), Channel State Information (CSI) with a higher CSI priority, and CSI with a lower CSI priority. In some embodiments, UCI type priorities are ordered from high to low as follows: HARQ-ACK, SR, CSI with a higher CSI priority, and CSI with a lower CSI priority.

In some embodiments, the step of performing the uplink transmission comprising multiple UCIs that are mapped to different codewords, respectively, comprises: constructing a bit sequence by concatenating the multiple UCIs in a decreasing or increasing order of their type priorities; and segmenting the bit sequence into multiple segments such that the multiple segments are mapped to the multiple codewords in an one-to-one manner. In some embodiments, one or more first transmission parameters are configured for a TB associated with the first codeword, one or more second transmission parameters are configured for a TB associated with the second codeword, and at least one of the first transmission parameters has a first value that achieves a higher reliability than that achieved by a second value of a corresponding one of the second transmission parameters. In some embodiments, the one or more transmission parameters comprise at least one of: —MCS; and —the number of transmission layers.

In some embodiments, the multiple UCI are mapped to one of the multiple codewords that has the lowest MCS index and/or the greatest number of transmission layers. In some embodiments, the bits of the multiple UCIs are repeated for at least two codewords. In some embodiments, the bits of the multiple UCIs are repeated for all codewords. In some embodiments, a part of the bits of the multiple UCIs that is mapped to a codeword is rate matched according to the number of transmission layers and/or MCS level associated with the corresponding codeword. In some embodiments, a first UCI having a first combination of UCI type priority and PHY transmission priority is mapped to a first codeword while a second UCI having a second combination of UCI type priority and PHY transmission priority is mapped to a second codeword that is different from the first codeword, and the second combination of UCI type priority and PHY transmission priority is different from the first combination of UCI type priority and PHY transmission priority. In some embodiments, each of the multiple UCI has one of multiple UCI type priorities and one of multiple physical layer (PHY) transmission priorities, wherein a first UCI having a first combination of UCI type priority and PHY transmission priority is mapped to a first codeword while a second UCI having a second combination of UCI type priority and PHY transmission priority that is different from the first combination is mapped to a second codeword that is different from the first codeword. In some embodiments, at least two of following combinations of UCI type priority and PHY transmission priority are ordered from high to low in their listed order: —HARQ-ACK with a high PHY transmission priority; —SR with a high PHY transmission priority; —CSI with a higher CSI priority and a high PHY transmission priority; —CSI with a lower CSI priority and a high PHY transmission priority; —HARQ-ACK with a low PHY transmission priority; —SR with a low PHY transmission priority; —CSI with a higher CSI priority and a low PHY transmission priority; and —CSI with a lower CSI priority and a low PHY transmission priority. In some embodiments, combinations of UCI type priority and PHY transmission priority are ordered from high to low as follows: —HARQ-ACK with a high PHY transmission priority; —SR with a high PHY transmission priority; —CSI with a higher CSI priority and a high PHY transmission priority; —CSI with a lower CSI priority and a high PHY transmission priority; —HARQ-ACK with a low PHY transmission priority; —SR with a low PHY transmission priority; —CSI with a higher CSI priority and a low PHY transmission priority; and —CSI with a lower CSI priority and a low PHY transmission priority. In some embodiments, at least two of following combinations of UCI type priority and PHY transmission priority are ordered from high to low in their listed order: —HARQ-ACK with a high PHY transmission priority; —SR with a high PHY transmission priority; —HARQ-ACK with a low PHY transmission priority; —SR with a low PHY transmission priority; —CSI with a higher CSI priority and a high PHY transmission priority; —CSI with a lower CSI priority and a high PHY transmission priority; —CSI with a higher CSI priority and a low PHY transmission priority; and —CSI with a lower CSI priority and a low PHY transmission priority. In some embodiments, combinations of UCI type priority and PHY transmission priority are ordered from high to low as follows: —HARQ-ACK with a high PHY transmission priority; —SR with a high PHY transmission priority; —HARQ-ACK with a low PHY transmission priority; —SR with a low PHY transmission priority; —CSI with a higher CSI priority and a high PHY transmission priority; —CSI with a lower CSI priority and a high PHY transmission priority; —CSI with a higher CSI priority and a low PHY transmission priority; and —CSI with a lower CSI priority and a low PHY transmission priority.

In some embodiments, before the step of performing the uplink transmission, the method further comprises: receiving, from at least one of the network nodes, a message for scheduling the uplink transmission and indicating that UL-SCH data is to be transmitted in the uplink transmission; and determining priorities for multiple TBs associated with the multiple codewords at least partially based on the received message. In some embodiments, the priorities for multiple TBs are determined based on at least one of: —a priority indicator field in the received message; —a codeword (CW) priority field in the received message; —a relative MCS index value; —a relative number of transmission layers; and —a relative size of TB. In some embodiments, the priorities for multiple TBs are determined based on at least one of: —a UCI type priority of a UCI to be multiplexed with the uplink transmission; —a PHY transmission priority of a UCI to be multiplexed with the uplink transmission; —relative codeword priorities for the multiple codewords; and —a PHY transmission priority of the uplink transmission. In some embodiments, the PHY transmission priority of the uplink transmission is determined by a priority indicator field in the received message when the received message is a DCI message, or the PHY transmission priority of the uplink transmission is determined by a “phy-PriorityIndex” field in the received message when the received message is an RRC message.

In some embodiments, a first UCI with a high PHY transmission priority is multiplexed with a codeword having a high codeword priority, and a second UCI with a low PHY transmission priority is multiplexed with another codeword having a low codeword priority. In some embodiments, at least one of UCIs is multiplexed with a codeword having a pre-determined or configured codeword priority. In some embodiments, all UCIs are multiplexed with a codeword having a pre-determined or configured codeword priority. In some embodiments, a first UCI with a high overall priority is multiplexed with a first codeword, and a second UCI with a low overall priority is multiplexed with a second codeword that has a lower codeword priority than the first codeword, wherein an overall priority for a UCI is determined based on at least one of: —PHY transmission priority for the UCI; and —UCI type priority for the UCI. In some embodiments, no UCI that has an overall priority lower than the PHY transmission priority of the uplink transmission is allowed to be multiplexed with the uplink transmission. In some embodiments, a first UCI with a first PHY transmission priority is multiplexed with a first codeword having a high codeword priority, and a second UCI with a second PHY transmission priority lower than the first PHY transmission priority is multiplexed with a second codeword having a low codeword priority.

In some embodiments, before the step of performing the uplink transmission, the method further comprises: receiving, from at least one of the network nodes, a message indicating which type or part of UCI is to be multiplexed with which codeword. In some embodiments, which type or part of UCI is to be multiplexed with which codeword is predetermined. In some embodiments, HARQ-ACK and SR are to be multiplexed with a first codeword, and/or CSI is to be multiplexed with a second codeword. In some embodiments, the uplink transmission is performed with a repetition type A or a repetition Type B. In some embodiments, the uplink transmission is performed with at least one of: —inter-repetition frequency hopping (FH); —intra-slot FH; and —inter-slot FH. In some embodiments, the uplink transmission is performed with one of: —inter-repetition frequency hopping (FH); —intra-slot FH; and —inter-slot FH. In some embodiments, at least one of repetitions of the uplink transmission carries the multiple codewords. In some embodiments, each repetition of the uplink transmission carries the multiple codewords. In some embodiments, a first repetition of the uplink transmission carries a full set of the multiple codewords, and a second repetition of the uplink transmission carries a subset of the multiple codewords. In some embodiments, a first repetition of the uplink transmission carries a full set of the multiple codewords, and a second repetition of the uplink transmission carries a proper subset of the multiple codewords. In some embodiments, the uplink transmission is PUSCH transmission. In some embodiments, the network node is a Transmission Reception Point (TRP).

According to a second aspect of the present disclosure, a UE is provided. The UE comprises: a processor; a memory storing instructions which, when executed by the processor, cause the processor to perform the method of any of the first aspect.

According to a third aspect of the present disclosure, a UE is provided. The UE comprises: an uplink transmission module for performing, with one or more network nodes, an uplink transmission with multiple codewords.

According to a fourth aspect of the present disclosure, a method at a network node for uplink transmission with multiple codewords from a UE is provided. The method comprises: performing, with the UE, an uplink transmission with multiple codewords.

In some embodiments, before the step of performing the uplink transmission, the method further comprises: receiving, from the UE, a message indicating whether uplink transmission with multiple codewords is supported by the UE or not. In some embodiments, the message indicates at least one of: —whether CG based uplink transmission with multiple codewords is supported by the UE or not; —whether Type 1 CG based uplink transmission with multiple codewords is supported by the UE or not; —whether Type 2 CG based uplink transmission with multiple codewords is supported by the UE or not; and —whether DG based uplink transmission with multiple codewords is supported by the UE or not. In some embodiments, the message only indicates whether DG based uplink transmission with multiple codewords is supported by the UE or not. In some embodiments, after the step of receiving the message, the method further comprises: transmitting, to the UE, a configuration indicating whether a single codeword or multiple codewords shall be used by the UE for its uplink transmission. In some embodiments, the configuration is transmitted via UE-specific RRC signaling.

In some embodiments, when the uplink transmission is Type 2 CG-based uplink transmission or DG based uplink transmission and before the step of performing the uplink transmission, the method further comprises: transmitting, to the UE, at least one DCI message for scheduling the uplink transmission. In some embodiments, for at least one of the multiple codewords, the DCI message comprises at least one field for at least one of: —an MCS; —an NDI; and —an RV. In some embodiments, the DCI message is a DCI message of a legacy DCI format. In some embodiments, the DCI message is a DCI format 0_0, 0_1 or 0_2 message. In some embodiments, the DCI message is not a DCI message of a legacy DCI format. In some embodiments, the step of transmitting, to the UE, a DCI message for scheduling the uplink transmission comprises: transmitting, to the UE, the DCI message for scheduling at least a part of the uplink transmission. In some embodiments, the multiple DCI messages comprise at least a first DCI message scheduling one or more parameters for a first of the multiple codewords and a second DCI message scheduling one or more parameters for a second of the multiple codewords. In some embodiments, when the uplink transmission is Type 1 CG-based uplink transmission and before the step of performing the uplink transmission, the method further comprises: transmitting, to the UE, an RRC message scheduling the uplink transmission. In some embodiments, for at least one of the multiple codewords, the RRC message comprises at least one field for at least one of: —an MCS index; —an MCS table; —information for precoding and number of layers; and —an SRI. In some embodiments, the RRC message comprises a ConfiguredGrantConfig IE that comprises at least one of: —a precodingAndNumberOfLayers2ndTB IE for configuring the information for precoding and number of layers for a codeword; —a srs-ResourceIndicator2ndTB IE for configuring the SRI for the codeword; and —a mcsAndTBS2ndTB IE for configuring modulation order, target code rate, and/or TB size for the codeword.

In some embodiments, before the step of performing the uplink transmission, the method further comprises: transmitting, to the UE, an RRC message indicating a maximum number of codewords for uplink transmission. In some embodiments, the RRC message comprises at least one of: —a maxNrofCodeWordsScheduledByDCI-0-1 IE in a PUSCH-Config IE indicating a maximum number of codewords for DG based uplink transmission scheduled by a DCI format 0_1 message; —a maxNrofCodeWordsScheduledByDCI-0-2 IE in a PUSCH-Config IE indicating a maximum number of codewords for DG based uplink transmission scheduled by a DCI format 0_2 message; —a maxNrofCodeWords IE in a PUSCH-Config IE indicating a maximum number of codewords for any uplink transmission to the at least one network node; —a maxNrofCodeWordsScheduledByDCI-0-1 IE in a PUSCH-Config IE indicating a maximum number of codewords for DG based uplink transmission and/or Type 2 CG based uplink transmission scheduled by a DCI format 0_1 message; —a maxNrofCodeWordsScheduledByDCI-0-2 IE in a PUSCH-Config IE indicating a maximum number of codewords for DG based uplink transmission and/or Type 2 CG based uplink transmission scheduled by a DCI format 0_2 message; —a maxNrofCodeWordsScheduledByRRC IE in a PUSCH-Config IE indicating a maximum number of codewords for Type 1 CG based uplink transmission schedule by RRC signaling; and —a maxNrofCodeWords IE in a ConfiguredGrantConfig IE indicating a maximum number of codewords for CG based uplink transmission.

In some embodiments, the uplink transmission is targeted towards multiple network nodes comprising the network node. In some embodiments, the uplink transmission comprises at least one or more first transmission layers targeted towards the network node and one or more second transmission layers targeted towards one or more other network nodes. In some embodiments, at least two of the transmission layers are transmitted over a same time-frequency resource. In some embodiments, all the transmission layers are transmitted over a same time-frequency resource. In some embodiments, for at least two of the multiple network nodes, the uplink transmission comprises a same or different number of transmission layers targeted towards the corresponding network node. In some embodiments, for each of the multiple network nodes, the uplink transmission comprises a same or different number of transmission layers targeted towards the corresponding network node. In some embodiments, the uplink transmission is DG based uplink transmission or Type 2 CG based uplink transmission. In some embodiments, one or more DCI messages that are transmitted by the network node and schedule the uplink transmission comprise, for at least one of the multiple codewords, at least one of: —MCS; —RV; —TPMI and/or a number of transmission layers when the uplink transmission is a codebook based uplink transmission; and —one or more SRIs. In some embodiments, one or more DCI messages that are transmitted by the network node and schedule the uplink transmission comprise, for each of the multiple codewords, at least one of: —MCS; —RV; —TPMI and/or a number of transmission layers when the uplink transmission is a codebook based uplink transmission; and —one or more SRIs. In some embodiments, when the uplink transmission is codebook based uplink transmission, the one or more DCI messages comprise, for at least one of the multiple codewords, a single or no SRI, wherein when the uplink transmission is non-codebook based uplink transmission, the one or more DCI messages comprise, for at least one of the multiple codewords, one or more SRIs. In some embodiments, when the uplink transmission is codebook based uplink transmission, the one or more DCI messages comprise, for each of the multiple codewords, a single or no SRI, wherein when the uplink transmission is non-codebook based uplink transmission, the one or more DCI messages comprise, for each of the multiple codewords, one or more SRIs. In some embodiments, a first SRI configured for a first codeword indicates an SRS resource from a first SRS resource set, wherein a second SRI configured for a second codeword indicates an SRS resource from a second SRS resource set that is different from the first SRS resource set.

In some embodiments, the method further comprises: transmitting, to the UE, a message indicating that at least one of the multiple codewords is disabled; and performing, with the UE, another uplink transmission with the at least one codeword disabled. In some embodiments, the message is a DCI message comprising multiple fields, and a combination of specific values of the one or more of the multiple fields indicates that a corresponding codeword is disabled. In some embodiments, the method further comprises: transmitting, to the UE, a message indicating a configuration for DMRS ports for the multiple codewords. In some embodiments, the message is a DCI message comprising a single antenna port field that indicates the configuration for DMRS ports for the multiple codewords. In some embodiments, the single antenna port field is encoded by at least one of: —referring to one or more first antenna port tables when the transform precoder is disabled and when a number of transmission layers is less than or equal to 4; —referring to one or more second antenna port tables that are different from the one or more first antenna port tables when the transform precoder is disabled and when the number of transmission layers is greater than 4; and —referring to one or more third antenna port tables when the transform precoder is enabled. In some embodiments, the single antenna port field is encoded as follows: —referring to one or more first antenna port tables when the transform precoder is disabled and when a number of transmission layers is less than or equal to 4; —referring to one or more second antenna port tables that are different from the one or more first antenna port tables when the transform precoder is disabled and when the number of transmission layers is greater than 4; and —referring to one or more third antenna port tables when the transform precoder is enabled.

In some embodiments, before the step of performing the uplink transmission, the method further comprises: transmitting, to the UE, a DCI message for scheduling the uplink transmission and indicating that no UL-SCH data is to be transmitted in the uplink transmission, wherein the step of performing the uplink transmission comprises: performing the uplink transmission comprising multiple UCI that are mapped to one or more codewords. In some embodiments, a first UCI having a first UCI type priority is mapped to a first codeword while a second UCI having a second UCI type priority is mapped to a second codeword that is different from the first codeword, and the second UCI type priority is lower than the first UCI type priority. In some embodiments, each of the multiple UCI has one of multiple UCI type priorities, wherein a first UCI having a first UCI type priority is mapped to a first codeword while a second UCI having a second UCI type priority that is lower than the first UCI type priority is mapped to a second codeword that is different from the first codeword. In some embodiments, UCI type priorities of at least two of following are ordered from high to low in their listed order: HARQ-ACK, SR, CSI with a higher CSI priority, and CSI with a lower CSI priority. In some embodiments, UCI type priorities are ordered from high to low as follows: HARQ-ACK, SR, CSI with a higher CSI priority, and CSI with a lower CSI priority. In some embodiments, the step of performing the uplink transmission comprising multiple UCIs that are mapped to different codewords, respectively, comprises: receiving, from the UE, the uplink transmission; decoding the uplink transmission to determine multiple segments that are mapped to the multiple codewords of the uplink transmission in an one-to-one manner; and determining the multiple UCIs that are ordered in a decreasing or increasing order of their type priorities from the multiple segments.

In some embodiments, one or more first transmission parameters are configured for a TB associated with the first codeword while one or more second transmission parameters are configured for a TB associated with the second codeword, and at least one of the first transmission parameters has a first value that achieves a higher reliability than that achieved by a second value of a corresponding one of the second transmission parameters. In some embodiments, one or more transmission parameters that are configured for a TB associated with the first codeword have values for achieving a higher reliability than that achieved by one or more corresponding transmission parameters that are configured for a TB associated with the second codeword. In some embodiments, the one or more transmission parameters comprise at least one of: —MCS; and —the number of transmission layers. In some embodiments, the multiple UCI are mapped to one of the multiple codewords that has the lowest MCS index and/or the greatest number of transmission layers. In some embodiments, the bits of the multiple UCIs are repeated for at least two codewords. In some embodiments, the bits of the multiple UCIs are repeated for all codewords.

In some embodiments, a part of the bits of the multiple UCIs that is mapped to a codeword is rate matched according to the number of transmission layers and/or MCS level associated with the corresponding codeword. In some embodiments, a first UCI having a first combination of UCI type priority and PHY transmission priority is mapped to a first codeword while a second UCI having a second combination of UCI type priority and PHY transmission priority is mapped to a second codeword that is different from the first codeword, and the second combination of UCI type priority and PHY transmission priority is different from the first combination of UCI type priority and PHY transmission priority. In some embodiments, each of the multiple UCI has one of multiple UCI type priorities and one of multiple PHY transmission priorities, wherein a first UCI having a first combination of UCI type priority and PHY transmission priority is mapped to a first codeword while a second UCI having a second combination of UCI type priority and PHY transmission priority that is different from the first combination is mapped to a second codeword that is different from the first codeword. In some embodiments, at least two of following combinations of UCI type priority and PHY transmission priority are ordered from high to low in their listed order: —HARQ-ACK with a high PHY transmission priority; —SR with a high PHY transmission priority; —CSI with a higher CSI priority and a high PHY transmission priority; —CSI with a lower CSI priority and a high PHY transmission priority; —HARQ-ACK with a low PHY transmission priority; —SR with a low PHY transmission priority; —CSI with a higher CSI priority and a low PHY transmission priority; and —CSI with a lower CSI priority and a low PHY transmission priority. In some embodiments, combinations of UCI type priority and PHY transmission priority are ordered from high to low as follows: —HARQ-ACK with a high PHY transmission priority; —SR with a high PHY transmission priority; —CSI with a higher CSI priority and a high PHY transmission priority; —CSI with a lower CSI priority and a high PHY transmission priority; —HARQ-ACK with a low PHY transmission priority; —SR with a low PHY transmission priority; —CSI with a higher CSI priority and a low PHY transmission priority; and —CSI with a lower CSI priority and a low PHY transmission priority. In some embodiments, at least two of following combinations of UCI type priority and PHY transmission priority are ordered from high to low in their listed order: —HARQ-ACK with a high PHY transmission priority; —SR with a high PHY transmission priority; —HARQ-ACK with a low PHY transmission priority; —SR with a low PHY transmission priority; —CSI with a higher CSI priority and a high PHY transmission priority; —CSI with a lower CSI priority and a high PHY transmission priority; —CSI with a higher CSI priority and a low PHY transmission priority; and —CSI with a lower CSI priority and a low PHY transmission priority. In some embodiments, combinations of UCI type priority and PHY transmission priority are ordered from high to low as follows: —HARQ-ACK with a high PHY transmission priority; —SR with a high PHY transmission priority; —HARQ-ACK with a low PHY transmission priority; —SR with a low PHY transmission priority; —CSI with a higher CSI priority and a high PHY transmission priority; —CSI with a lower CSI priority and a high PHY transmission priority; —CSI with a higher CSI priority and a low PHY transmission priority; and —CSI with a lower CSI priority and a low PHY transmission priority.

In some embodiments, before the step of performing the uplink transmission, the method further comprises: determining priorities for multiple TBs associated with the multiple codewords; and transmitting, to the UE, a message for scheduling the uplink transmission and indicating that UL-SCH data is to be transmitted in the uplink transmission at least partially based on the determined priorities for the multiple TBs. In some embodiments, the priorities for the multiple TBs are determined based on at least one of: —a priority indicator field in the received message; —a CW priority field in the received message; —a relative MCS index value; —a relative number of transmission layers; and —a relative size of TB. In some embodiments, the priorities for multiple TBs are determined based on at least one of: —a UCI type priority of a UCI to be multiplexed with the uplink transmission; —a PHY transmission priority of a UCI to be multiplexed with the uplink transmission; —relative codeword priorities for the multiple codewords; and —a PHY transmission priority of the uplink transmission.

In some embodiments, the PHY transmission priority of the uplink transmission is determined by a priority indicator field in the received message when the received message is a DCI message, or the PHY transmission priority of the uplink transmission is determined by a “phy-PriorityIndex” field in the received message when the received message is an RRC message. In some embodiments, a first UCI with a high PHY transmission priority is multiplexed with a codeword having a high codeword priority, and a second UCI with a low PHY transmission priority is multiplexed with another codeword having a low codeword priority. In some embodiments, at least one of UCIs is multiplexed with a codeword having a pre-determined or configured codeword priority. In some embodiments, all UCIs are multiplexed with a codeword having a pre-determined or configured codeword priority. In some embodiments, a first UCI with a high overall priority is multiplexed with a first codeword, and a second UCI with a low overall priority is multiplexed with a second codeword that has a lower codeword priority than the first codeword, wherein an overall priority for a UCI is determined based on at least one of: —PHY transmission priority for the UCI; and —UCI type priority for the UCI. In some embodiments, no UCI that has an overall priority lower than the PHY transmission priority of the uplink transmission is allowed to be multiplexed with the uplink transmission. In some embodiments, a first UCI with a first PHY transmission priority is multiplexed with a first codeword having a high codeword priority, and a second UCI with a second PHY transmission priority lower than the first PHY transmission priority is multiplexed with a second codeword having a low codeword priority.

In some embodiments, before the step of performing the uplink transmission, the method further comprises: transmitting, to the UE, a message indicating which type or part of UCI is to be multiplexed with which codeword. In some embodiments, which type or part of UCI is to be multiplexed with which codeword is predetermined. In some embodiments, HARQ-ACK and SR are to be multiplexed with a first codeword, and/or CSI is to be multiplexed with a second codeword. In some embodiments, the uplink transmission is performed with a repetition type A or a repetition Type B. In some embodiments, the uplink transmission is performed with at least one of: —inter-repetition FH; —intra-slot FH; and —inter-slot FH. In some embodiments, the uplink transmission is performed with one of: —inter-repetition FH; —intra-slot FH; and —inter-slot FH. In some embodiments, each repetition of the uplink transmission carries the multiple codewords. In some embodiments, a first repetition of the uplink transmission carries a full set of the multiple codewords, and a second repetition of the uplink transmission carries a subset of the multiple codewords. In some embodiments, a first repetition of the uplink transmission carries a full set of the multiple codewords, and a second repetition of the uplink transmission carries a proper subset of the multiple codewords. In some embodiments, the uplink transmission is PUSCH transmission. In some embodiments, the network node is a TRP.

According to a fifth aspect of the present disclosure, a network node is provided. The network node comprises: a processor; a memory storing instructions which, when executed by the processor, cause the processor to perform the method of any of the fourth aspect.

According to a sixth aspect of the present disclosure, a network node is provided. The network node comprises: an uplink transmission module for performing, with the UE, an uplink transmission with multiple codewords.

According to a seventh aspect of the present disclosure, a computer program comprising instructions is provided. The instructions, when executed by at least one processor, cause the at least one processor to carry out the method of any of the first or fourth aspect.

According to an eighth aspect of the present disclosure, a carrier containing the computer program of the fifth aspect is provided. The carrier is one of an electronic signal, optical signal, radio signal, or computer readable storage medium.

According to a ninth aspect of the present disclosure, a telecommunications system is provided. The telecommunications system comprises at least one UE of the second or third aspect; and one or more network nodes of the fifth or sixth aspect.

With the above embodiments of the present disclosure, multiple-codeword uplink transmission is enabled. Further, with the above embodiments of the present disclosure, UCI may be transmitted on PUSCH when multiple codewords are used. Furthermore, with the above embodiments of the present disclosure, repetition of PUSCH with multiple codewords is also enabled. In general, a higher throughput, a higher reliability, or a faster response for the uplink transmission may be achieved.

### BRIEF DESCRIPTION OF THE DRAWINGS

FIG. 1 shows flow charts illustrating exemplary Type-1 and Type-2 CG based PUSCH transmission procedures, respectively, with which a UE and gNB according to an embodiment of the present disclosure may be operable.

FIG. 2 shows a flow chart illustrating an exemplary DG based PUSCH transmission procedure with which a UE and gNB according to an embodiment of the present disclosure may be operable.

FIG. 3 is a diagram illustrating an exemplary NR time domain structure with 15 kHz subcarrier spacing with which a UE and gNB according to an embodiment of the present disclosure may be operable.

FIG. 4 is a diagram illustrating an exemplary NR physical resource grid with which a UE and gNB according to an embodiment of the present disclosure may be operable.

FIG. 5 is a diagram illustrating exemplary multiplexing of UCI on PUSCH that is applicable to a UE and gNB according to an embodiment of the present disclosure.

FIG. 6 is a diagram illustrating exemplary PUSCH transmissions with multiple codewords targeting toward multiple TRPs according to an embodiment of the present disclosure.

FIG. 7 is a flow chart illustrating an exemplary method at a UE for uplink transmission with multiple codewords according to an embodiment of the present disclosure.

FIG. 8 is a flow chart illustrating an exemplary method at a network node for uplink transmission with multiple codewords according to an embodiment of the present disclosure.

FIG. 9 schematically shows an embodiment of an arrangement which may be used in a UE or a network node according to an embodiment of the present disclosure.

FIG. 10 is a block diagram of an exemplary UE according to an embodiment of the present disclosure.

FIG. 11 is a block diagram of an exemplary network node according to an embodiment of the present disclosure.

FIG. 12 schematically illustrates a telecommunication network connected via an intermediate network to a host computer according to an embodiment of the present disclosure.

FIG. 13 is a generalized block diagram of a host computer communicating via a base station with a user equipment over a partially wireless connection according to an embodiment of the present disclosure.

FIG. 14 to FIG. 17 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as uplink transmission with multiple codewords is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents. Further, please note that the term “indicator” used herein may refer to a parameter, a coefficient, an attribute, a property, a setting, a configuration, a profile, an identifier, a field, one or more bits/octets, an information element, or any data by which information of interest may be indicated directly or indirectly.

Further, following 3GPP documents are incorporated herein by reference in their entireties:
3GPP TS 38.211 V16.6.0 (2021-06), 3rd Generation Partnership Project; Technical Specification Group Radio Access Network; NR; Physical channels and modulation (Release 16);
3GPP TS 38.212 V16.6.0 (2021-06), 3rd Generation Partnership Project; Technical Specification Group Radio Access Network; NR; Multiplexing and channel coding (Release 16);
3GPP TS 38.213 V16.6.0 (2021-06), 3rd Generation Partnership Project; Technical Specification Group Radio Access Network; NR; Physical layer procedures for control (Release 16); and
3GPP TS 38.214 V16.6.0 (2021-06), 3rd Generation Partnership Project; Technical Specification Group Radio Access Network; NR; Physical layer procedures for data (Release 16).

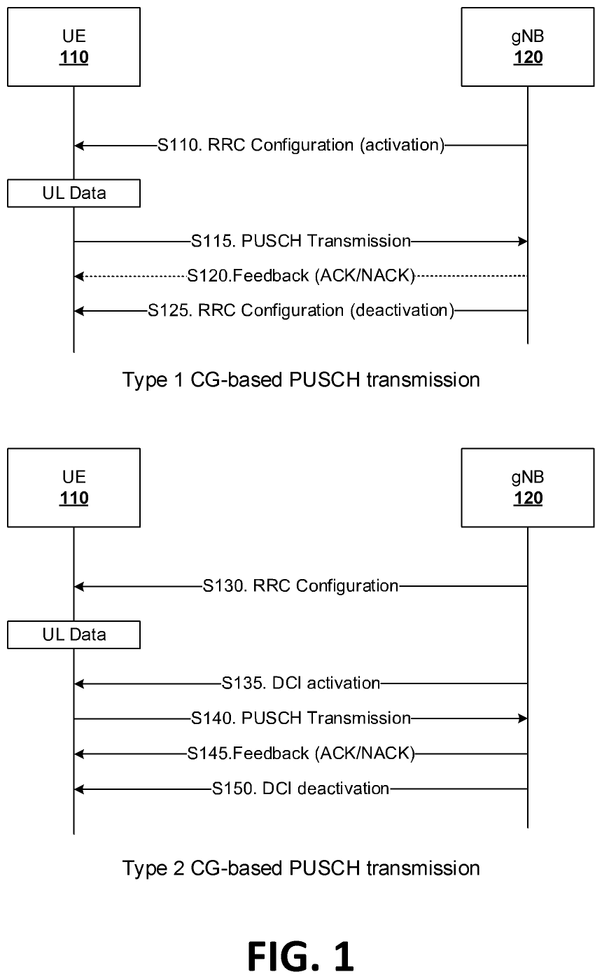

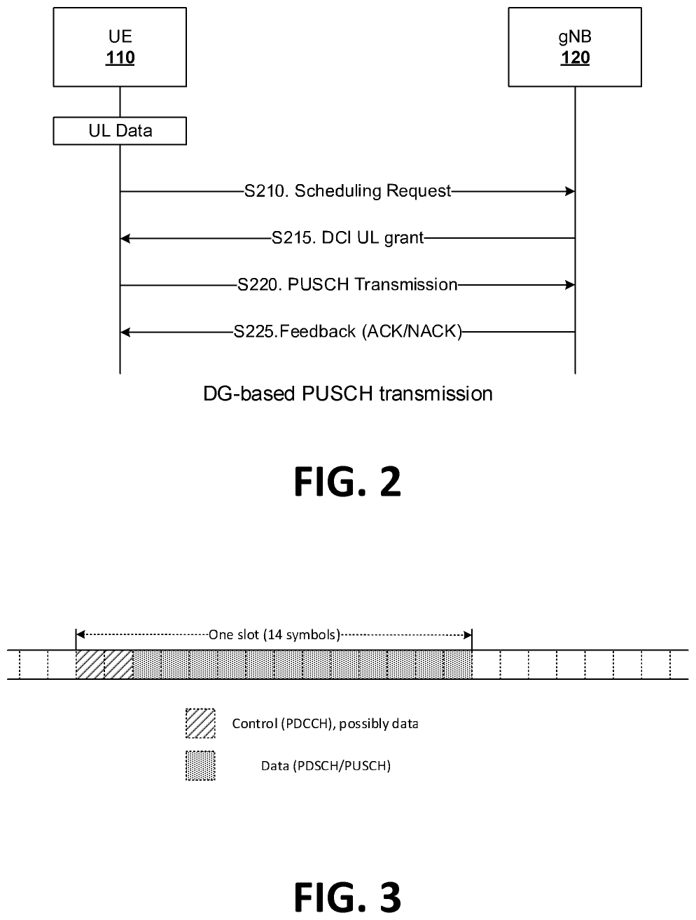

FIG. 1 shows flow charts illustrating exemplary Type-1 and Type-2 CG based PUSCH transmission procedures, respectively, with which the UE 110 and the gNB 120 according to an embodiment of the present disclosure may be operable. FIG. 2 shows a flow chart illustrating an exemplary DG based PUSCH transmission procedure with which the UE 110 and the gNB 120 according to an embodiment of the present disclosure may be operable.

As shown in FIG. 2, a procedure for uplink data transmission based on dynamic UL grant (also known as dynamic scheduling) will be described. Whenever there is UL data to be transmitted from the UE 110 to the gNB 120, the UE 110 may ask the gNB 120 about uplink grant using “scheduling request” message over the PUCCH channel (when UE 110 is in the connected state) or PRACH channel (e.g., when the UE 110 is attempting initial access), as shown at step S210. The gNB 120 may reply the UE 110 with an uplink grant, for example, in a DCI 0_0, DCI 0_1, or DCI 0_2 message over the PDCCH channel at step S215. Upon reception of the uplink grant which may assign the UE 110 with uplink resources for uplink data transmission, the UE 110 may start transmitting the data over the assigned resources over the PUSCH channel at step S220. Upon reception of the UL data, at step S225, the gNB 120 may provide a feedback (ACK/NACK) to the UE 110 such that the UL data may be retransmitted if the initial transmission fails.

However, 5G networks are expected to support applications demanding ultra-reliable and low latency communication (URLLC) services. To support these kinds of applications, 5G-NR introduced grant free uplink transmission feature a.k.a. Transmission without grant (TWG) or Configured Grant (CG) based PUSCH transmission, i.e., data transmission without resource request. Transmission without grant can avoid the regular handshake delay e.g., sending the scheduling request (e.g., step S210) and waiting for UL grant allocation (e.g., step S215). Another advantage is that it may relax the stringent reliability requirements on control channels.

As shown in FIG. 1, a PUSCH channel may be semi-statically (Type-1) or semi-persistently (Type 2) configured by UL grant via RRC (Layer 3) signaling, which is also referred to as grant free configuration scheme. There are two types of grant free configuration schemes supported in 5G NR:
CG Type 1: Uplink grant configuration, activation/deactivation provided by RRC signaling, shown as steps S110 and S125;
CG Type 2: Uplink grant configuration provided via RRC signaling and its activation/deactivation via PDCCH grant (via UL DCIs), shown as steps S135 and S150.

The IE ConfiguredGrantConfig may be used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one Bandwidth Part (BWP) of a serving cell.

CG Type 1 is very much similar to LTE semi-persistent scheduling (SPS) where UL data transmission is based on RRC reconfiguration without any L1 signaling. The gNB 120 may provide the grant configuration to the UE 110 through a higher layer parameter, such as ConfiguredGrantConfig comprising the parameter rrc-ConfiguredUplinkGrant without the detection of any UL grant in a DCI. Potentially SPS scheduling can provide the suitability for deterministic URLLC traffic pattern, because the traffic properties can be well matched by appropriate resource configuration.

To be specific, at step S110, the gNB 120 may provide an RRC configuration to the UE 110 for activating a semi-static UL resource for the UE 110's UL data transmission. Whenever there is data to be transmitted by the UE 110 to the gNB 120, the UE 110 may use the configured UL resource to deliver the data at step S115. At Step S120, the gNB 120 may implicitly or explicitly provide feedbacks on the data received from the UE 110 with ACK/NACK. For example, in NR CG transmission up to NR Rel-16, there is no explicit ACK feedback from the gNB 120 to the UE 110 for operation in licensed spectrum. In other words, an ACK may be implicitly signaled, and a NACK may be explicitly signaled. A timer T may start when a TB is transmitted, and if no explicit NACK (dynamic grant) is received before the timer T expires the UE assumes ACK, otherwise UE will do retransmission using the dynamic grant provided in DCI with CRC scrambled by CS-RNTI. Furthermore, for operation in unlicensed spectrum, there could be some explicit HARQ feedback in DCI, which is called DFI (downlink feedback indication) and only used in DCI format 0-1. However, the present disclosure is not limited thereto. In some other embodiments, an ACK may be explicitly signaled, and a NACK may be implicitly signaled. In some other embodiments, both ACK and NACK may be explicitly signaled.

After the transmission of the data, the gNB 120 may deactivate the semi-statically assigned resource by sending an RRC configuration release or deactivation at step S125.

CG Type 2 is involved an additional L1 signaling (DCI), where uplink is semi-persistently scheduled by an UL grant in a valid activation DCI at step S135. The grant is activated (step S135) and deactivated (step S150) through DCI scrambled with CS-RNTI. RRC only provides a higher layer parameter ConfiguredGrantConfig not comprising rrc-ConfiguredUplinkGrant (step S130). The DCI signaling can enable fast modification of semi-persistently allocated resources. In this way, it enables the flexibility of UL Grant Free transmission in term of URLLC traffic properties for example packet arrival rate, number of UEs sharing the same resource pool and/or packet size.

Note: Both type 1 and type 2 are configured by RRC per serving cell and per BWP. For the same serving cell, the NR MAC entity may be configured with either Type 1 or Type 2.

There is no specific Activation/Release procedure provided for CG type1. RRC signaling with parameter ConfiguredGrantConfig comprising the parameter rrc-ConfiguredUplinkGrant implicitly means that CG type 1 is activation. Also, for releasing no dedicated IE is sent by gNB 120, in order to release the CG scheduling configuration, the gNB 120 may just send an RRC reconfiguration release to the UE 110.

CG Type 2 scheduling activation or scheduling release happens via PDCCH decoded DCIs if the CRC of a corresponding DCI format is scrambled with CS-RNTI and the new data indicator field for the enabled transport block is set to “0”. Validation of the DCI format may be achieved if all fields for the DCI format are set according to special fields for UL grant type 2 scheduling activation or scheduling release. If validation is achieved, UE 110 may consider the information in the DCI format as valid activation or valid release of configured UL grant type 2.

NR may use CP-OFDM (Cyclic Prefix-Orthogonal Frequency Division Multiplexing) in both downlink (DL) (i.e. from a network node, gNB, or base station, to a user equipment or UE) and uplink (UL) (i.e. from UE to gNB). Discrete Fourier Transform (DFT) spread OFDM may also be supported in the uplink. In the time domain, NR downlink and uplink may be organized into equally sized subframes of 1 ms each. A subframe may be further divided into multiple slots of equal duration. The slot length may depend on subcarrier spacing. For example, for subcarrier spacing of Δf=15 kHz, there is only one slot per subframe, and each slot may consist of 14 OFDM symbols.

Data scheduling in NR is typically performed in a slot basis, and an example is shown in FIG. 3 with a 14-symbol slot. FIG. 3 is a diagram illustrating an exemplary NR time domain structure with 15 kHz subcarrier spacing with which a UE and gNB according to an embodiment of the present disclosure may be operable. As shown in FIG. 3, the first two symbols may contain PDCCH and the rest may contain physical shared data channel, either PDSCH or PUSCH.

Different subcarrier spacing values may be supported in NR. The supported subcarrier spacing values (also referred to as different numerologies) are given by Δf=(15×2^{μ}) kHz where μ∈{0, 1, 2, 3, 4}. Δf=15 kHz is the basic subcarrier spacing.

The slot durations at different subcarrier spacings are given by

$$\frac{1}{{2}^{μ}}$$

ms.

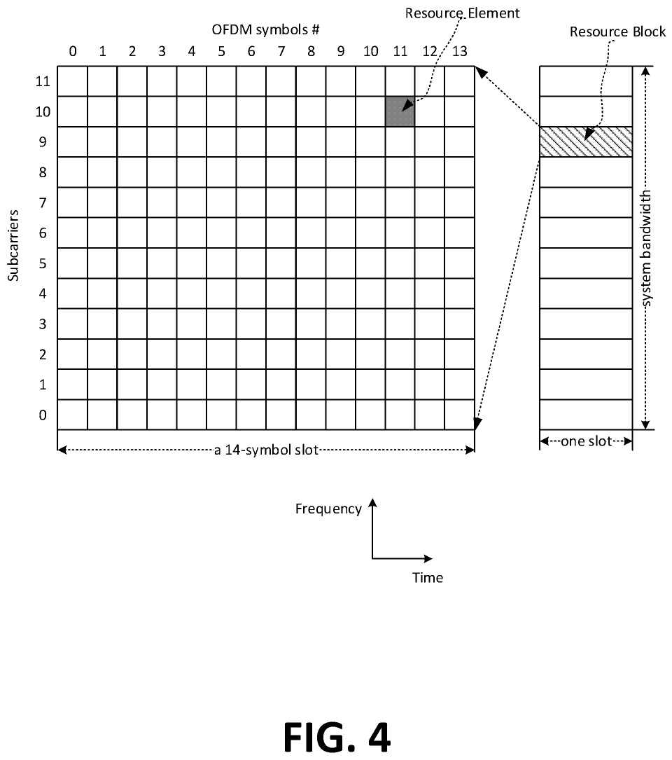

In the frequency domain, a system bandwidth may be divided into resource blocks (RBs), each corresponding to 12 contiguous subcarriers. The RBs are numbered starting with 0 from one end of the system bandwidth. The basic NR physical time-frequency resource grid is illustrated in FIG. 4.

FIG. 4 is a diagram illustrating an exemplary NR physical resource grid with which a UE and gNB according to an embodiment of the present disclosure may be operable. As shown in FIG. 4, only one RB within a 14-symbol slot is shown. One OFDM subcarrier during one OFDM symbol interval forms one resource element (RE).

In NR Rel-15, uplink data transmission can be dynamically scheduled using PDCCH. A UE may first decode uplink grants in PDCCH and then transmits data over PUSCH based the decoded control information in the uplink grant such as modulation order, coding rate, uplink resource allocation, etc. In dynamic scheduling of PUSCH, there is also a possibility to configure semi-persistent transmission of PUSCH using CG as described with reference to FIG. 1. There are two types of CG based PUSCH defined in NR Rel-15. In CG type 1, a periodicity of PUSCH transmission as well as the time domain offset are configured by RRC. In CG type 2, a periodicity of PUSCH transmission may be configured by RRC and then the activation and release of such transmission is controlled by DCI, i.e. with a PDCCH.

Further, in NR, it is possible to schedule a PUSCH with time repetition, by the RRC parameter pusch-AggregationFactor (for dynamically scheduled PUSCH), and repK (for PUSCH with UL configured grant). In this case, the PUSCH is scheduled but transmitted in multiple adjacent slots (if the slot is available for UL) up until the number of repetitions as determined by the configured RRC parameter.

In the case of PUSCH with UL configured grant, the redundancy version (RV) sequence to be used may be configured by the repK-RV field when repetitions are used. If repetitions are not used for PUSCH with UL configured grant, then the repK-RV field is absent.

In NR Release-15, there are two mapping types supported, Type A and Type B, applicable to PDSCH and PUSCH transmissions. Type A is usually referred to as slot-based while Type B transmissions may be referred to as non-slot-based or mini-slot-based.

Mini-slot transmissions can be dynamically scheduled and for NR Rel-15:
Can be of length 7, 4, or 2 symbols for downlink, while it can be of any length for uplink; and
Can start and end in any symbol within a slot.

Please Note that mini-slot transmissions in NR Rel-15 may not cross the slot-border.

Further, one of 2 frequency hopping modes, inter-slot and intra-slot frequency hopping, can be configured via higher layer for PUSCH transmission in NR Rel-15, in IE PUSCH-Config for dynamic transmission or IE configuredGrantConfig for type1 and type2 CG.

In NR, there are two transmission schemes specified for PUSCH, i.e. codebook based and non-codebook based PUSCH transmissions.

The Codebook based UL transmission may be used on both NR and LTE and was motivated to be used for non-calibrated UEs and/or UL FDD (frequency division duplex). Codebook based PUSCH in NR is enabled if higher layer parameter txConfig=codebook. For dynamically scheduled PUSCH and configured grant PUSCH type 2, the Codebook based PUSCH transmission scheme can be summarized as follows:
The UE may transmit one or two SRS resources (i.e., one or two SRS resources configured in the SRS resource set associated with the higher layer parameter usage of value ‘CodeBook’). Note that in NR Rel-15/16, the number of SRS resource sets with higher layer parameter usage set to ‘CodeBook’ is limited to one (i.e., only one SRS resource set is allowed to be configured for the purposes of Codebook based PUSCH transmission).
The gNB may determine a preferred MIMO transmit precoder for PUSCH (i.e., transmit precoding matrix indicator or TPMI) from a codebook and the associated number of layers corresponding to the one or two SRS resources.
The gNB may indicate a selected SRS resource via a 1-bit ‘SRS resource indicator’ field if two SRS resources are configured in the SRS resource set. The ‘SRS resource indicator’ field is not indicated in DCI if only one SRS resource is configured in the SRS resource set.
The gNB may indicate a TPMI and the associated number of layers corresponding to the indicated SRS resource (in case 2 SRS resources are used) or the configured SRS resource (in case of 1 SRS resource is used). TPMI and the number of PUSCH layers may be indicated by the ‘Precoding information and number of layers’ field in DCI formats 0_1 and 0_2. The number of bits in the ‘Precoding information and number of layers’ for Codebook based PUSCH may be determined as follows:
   0 bits if 1 antenna port is used for PUSCH transmission.
   4, 5, or 6 bits according to Table 1 for 4 antenna ports, according to whether transform precoder is enabled or disabled, and the values of higher layer parameters maxRank, and codebookSubset. That is, ‘Precoding information and number of layers’ field size takes values of 6, 5, and 4 bits if codebookSubset is set to ‘fullyAndPartialAndNonCoherent’, ‘PartialAndNonCoherent’, and ‘NonCoherent’ respectively.

TABLE 1
Precoding information and number of layers, for 4 antenna ports, if transform
precoder is disabled and maxRank = 2 or 3 or 4 and ul-FullPowerTransmission
is not configured or configured to fullpowerMode2 or configured to fullpower

| Bit field | | Bit field | | Bit field | |
|---|---|---|---|---|---|
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | | |
| 19 | 1 layer: TPMI = 11 | 19 | 1 layer: TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layers: TPMI = 12 | | | | |
| . . . | . . . | | | | |
| 47 | 1 layers: TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

2, 4, or 5 bits according to Table 2 for 4 antenna ports, according to whether transform precoder is enabled or disabled, and the values of higher layer parameters maxRank, and codebookSubset. That is, ‘Precoding information and number of layers’ field size takes values of 5, 4, and 2 bits if codebookSubset is set to ‘fullyAndPartialAndNonCoherent’, ‘PartialAndNonCoherent’, and ‘NonCoherent’, respectively.

TABLE 2
Precoding information and number of layers for 4 antenna ports, if transform precoder is enabled,
or if transform precoder is disabled and ul-FullPowerTransmission is either not configured or
configured to fullpowerMode2, or if transform precoder is disabled, maxRank = 1, and ul-
FullPowerTransmission is not configured or configured to fullpowerMode2 or configured to fullpower

| Bit field | | Bit field | | Bit field | |
|---|---|---|---|---|---|
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 1 layer: TPMI = 4 | 4 | 1 layer: TPMI = 4 | | |
| . . . | . . . | . . . | . . . | | |
| 11 | 1 layer: TPMI = 11 | 11 | 1 layer: TPMI = 11 | | |
| 12 | 1 layers: TPMI = 12 | 12-15 | reserved | | |
| . . . | . . . | | | | |
| 27 | 1 layers: TPMI = 27 | | | | |
| 28-31 | reserved | | | | |

2 or 4 bits according to Table 3 for 2 antenna ports, according to whether transform precoder is enabled or disabled, and the values of higher layer parameters maxRank and codebookSubset. That is, ‘Precoding information and number of layers’ field size takes on values of 4 and 2 bits if codebookSubset is set to ‘fullyAndPartialAndNonCoherent’ and ‘NonCoherent’, respectively.

TABLE 3
Precoding information and number of layers, for 2 antenna
ports, if transform precoder is disabled, maxRank =
2, and ul-FullPowerTransmission is not configured or configured
to fullpowerMode2 or configured to fullpower

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

1 or 3 bits according to Table 4 for 2 antenna ports, if txConfig=codebook, and according to whether transform precoder is enabled or disabled, and the values of higher layer parameters maxRank and codebookSubset. That is, ‘Precoding information and number of layers’ field size takes on values of 3 and 1 bits if codebookSubset is set to ‘fullyAndPartialAndNonCoherent’ and ‘NonCoherent’, respectively.

TABLE 4
Precoding information and number of layers, for 2 antenna ports,
if transform precoder is enabled and ul-FullPowerTransmission is
not configured or configured to fullpowerMode2 or configured to
fullpower, or if transform precoder is disabled, maxRank =
1, and ul-FullPowerTransmission is not configured or
configured to fullpowerMode2 or configured to
fullpower

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 1 layer: TPMI = 2 | | |
| 3 | 1 layer: TPMI = 3 | | |
| 4 | 1 layer: TPMI = 4 | | |
| 5 | 1 layer: TPMI = 5 | | |
| 6-7 | reserved | | |

the UE may perform PUSCH transmission using the TPMI and number of layers indicated. If one SRS resource is configured in the SRS resource set associated with the higher layer parameter usage of value ‘CodeBook’, then the PUSCH DMRS may be spatially related to the most recent SRS transmission in this SRS resource. If two SRS resources are configured in the SRS resource set associated with the higher layer parameter usage of value ‘CodeBook’, then the PUSCH DMRS is spatially related to the most recent SRS transmission in the SRS resource indicated by the ‘SRS resource indicator’ field.

The TPMI may be used to indicate the precoder to be applied over the layers {0 . . . v-1} and that corresponds to the SRS resource selected by the SRI when multiple SRS resources are configured, or if a single SRS resource is configured TPMI is used to indicate the precoder to be applied over the layers {0 . . . v-1} and that corresponds to the SRS resource. The transmission precoder may be selected from the uplink codebook that has a number of antenna ports equal to higher layer parameter nrofSRS-Ports in SRS-Config.

Non-Codebook based UL transmission is available in NR, enabling reciprocity-based UL transmission. By assigning a DL CSI-RS to the UE, the UE may measure and deduce suitable precoder weights for PUSCH transmission of up to four spatial layers. The candidate precoder weights may be used to precode up to four single-port SRSs, and each precoded single-port SRS may be transmitted in an SRS resource. Each single-port SRS corresponds to a single PUSCH layer. Subsequently, the gNB may indicate the transmission rank and multiple SRS resource indicators, jointly encoded using

$$⌈ {log}_{2} ( {\sum }_{k = 1}^{m i n \{ {L}_{ma x} , {N}_{SRS} \}} ( \begin{matrix}{N}_{SRS} \\ k\end{matrix} ) ) ⌉ bits ,$$

where N_{SRS} indicates the number of configured SRS resources, and Lₘₐₓ is the maximum number of supported layers for PUSCH. Non-Codebook based PUSCH in NR is enabled if higher layer parameter txConfig=noncodebook. Table 5 shows the mapping of codepoints of the SRI field to SRI(s) for different number of N_{SRS} when Lₘₐₓ=4.

TABLE 5
SRI indication for non-codebook based
PUSCH transmission, Lₘₐₓ = 4

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14 | 0, 1, 2, 3 |
| | | | | 15 | reserved |

Note that in NR Rel-15/16, the number of SRS resource sets with higher layer parameter usage set to ‘nonCodeBook’ may be limited to one (i.e., only one SRS resource set is allowed to be configured for the purposes of non-Codebook based PUSCH transmission). The maximum number of SRS resources that can be configured for non-codebook based uplink transmission is 4.

In NR, for non-codebook based PUSCH, the UE may perform a one-to-one mapping from the indicated SRI(s) to the indicated DM-RS port(s) and their corresponding PUSCH layers {0 . . . v-1} in an increasing order. The UE may transmit PUSCH using the same antenna ports as the SRS port(s) in the SRS resource(s) indicated by SRI(s), where the SRS port in (i+1)^{th} SRS resource in the SRS resource set is indexed as pᵢ=1000+i.

With regards to Non-codebook based PUSCH, the following is specified in 3GPP TS 38.214 V16.6.0:

For non-codebook based transmission, the UE can calculate the precoder used for the transmission of SRS based on measurement of an associated NZP CSI-RS resource. A UE can be configured with only one NZP CSI-RS resource for the SRS resource set with higher layer parameter usage in SRS-ResourceSet set to ‘nonCodebook’ if configured.

Hence, for non-codebook based PUSCH transmission, only one NZP CSI-RS resource is configured in the SRS resource set, and the UE can calculate the precoder used for the transmission of SRS using this associated NZP CSI-RS resource. The single NZP CSI-RS resource configured per SRS resource set may be part of the SRS-Config information element and is shown below. The condition ‘NonCodebook’ may mean that the associated NZP CSI-RS is optionally present in case of the SRS resource set configured with usage set to ‘nonCodeBook’, otherwise the field is absent.

### SRS-Config Information Element

-- ASN1START
-- TAG-SRS-CONFIG-START
...

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF |

SRS-ResourceId OPTIONAL, -- Cond Setup

| | |
|---|---|
| resourceType | CHOICE { |

| aperiodic | | SEQUENCE { |
|---|---|---|
| | aperiodicSRS-ResourceTrigger | INTEGER (1..maxNrofSRS-TriggerStates-1), |
| | csi-RS NZP-CSI-RS-ResourceId | |
| OPTIONAL, | -- Cond NonCodebook | |
| | slotOffset | INTEGER (1..32) |
| OPTIONAL, | -- Need S | |
| | ..., | |
| | [[ | |
| | aperiodicSRS-ResourceTriggerList | SEQUENCE (SIZE(1..maxNrofSRS- |

TriggerStates-2))

OF INTEGER (1..maxNrofSRS-

TriggerStates-1) OPTIONAL -- Need M

]]

},

| | |
|---|---|
| semi-persistent | SEQUENCE { |

| | |
|---|---|
| | associatedCSI-RS NZP-CSI-RS-ResourceId |
| OPTIONAL, | -- Cond NonCodebook |
| | ... |

},

| | |
|---|---|
| periodic | SEQUENCE { |

| | |
|---|---|
| | associatedCSI-RS NZP-CSI-RS-ResourceId |
| OPTIONAL, | -- Cond NonCodebook |
| | ... |

```
    }
  },
```

| | |
|---|---|
| usage | ENUMERATED {beamManagement, codebook, nonCodebook, |

antennaSwitching},

| | |
|---|---|
| alpha | Alpha |

| | |
|---|---|
| OPTIONAL, | -- Need S |

| | |
|---|---|
| p0 | INTEGER (−202..24) |

| | |
|---|---|
| OPTIONAL, | -- Cond Setup |

| | |
|---|---|
| pathlossReferenceRS | CHOICE { |

| | |
|---|---|
| ssb-Index | SSB-Index, |
| csi-RS-Index | NZP-CSI-RS-ResourceId |

}

| | |
|---|---|
| srs-PowerControlAdjustmentStates | ENUMERATED { sameAsFci2, separateClosedLoop} |

| | |
|---|---|
| OPTIONAL, | -- Need S |

...
}

| | |
|---|---|
| SRS-ResourceSetId :: = | INTEGER (0..maxNrofSRS-ResourceSets-1) |

}
-- TAG-SRS-CONFIG-STOP
-- ASN1STOP

It is further specified in 3GPP TS 38.214 that if the UE is configured with an SRS resource set with an associated NZP CSI-RS resource, then the UE is not expected to be configured with spatial relation information in any of the SRS resources in the SRS resource set.

UCI on PUSCH can be ACK/NACK or CSI in the following ways, where different types of HARQ codebook are defined in section 9.1 of 38.213 V16.6.0, the DAI (downlink assignment index) is defined in the DCI format in 38.212 V16.6.0:
ACK/NACK with more than 2 bits and other UCI are rate matched, ACK/NACK with 1-2 bits is mapped via puncturing PUSCH data or CSI bits
   Due to code-block-group-based HARQ feedback, ACK/NACK size can be very large in NR→Puncturing large ACK/NACK into PUSCH leads to severe PUSCH performance degradation
DAI mechanism similar to LTE is used to indicate number of ACK/NACK bits for UCI on PUSCH
   DCI format 0_1 contains 1 bit UL DAI for fixed HARQ codebook, 2 bit UL DAI for dynamic HARQ codebook, and 2 bit UL DAI for dynamic HARQ codebook together with CBG configuration (one DAI for each sub-codebook)
   DCI format 0_0 does not contain any DAI
CSI can be split into two parts
Semi-statically configured and dynamically indicated beta values are supported
   Individual beta values can be set for ACK/NACK and CSI
   For dynamically indicated beta values, 2 bits in DCI format 0_1 select one value for ACK/NACK and CSI (n^{th} row in ACK/NACK and CSI table)

### Principles of UCI Mapping on PUSCH

CSI Part 1
   For rate matched ACK/NACK, CSI Part 1 is mapped from first available non-DM-RS symbol, mapping around ACK/NACK RES
   For puncturing ACK/NACK, CSI Part 1 is mapped from first available non-DM-RS symbol, mapping around those REs reserved for ACK/NACK puncturing (PUSCH and CSI Part 2 can be mapped on reserved resources, but will eventually be punctured)
CSI part 2 is mapped from first available non-DM-RS symbol, following CSI Part 1
   For puncturing ACK/NACK, CSI Part 2 can be mapped on resources reserved for ACK/NACK (and will then be punctured by ACK/NACK)
UCI is not FDMed (frequency division multiplexed) with DM-RS
Generally the following frequency-domain mapping procedure for all UCI types is used: Fill up symbol(s) completely with modulation symbols of one UCI type (if enough UCI modulation symbols are available); This is followed by one symbol where remaining UCI modulation symbols of this type are mapped on a comb across PUSCH bandwidth.

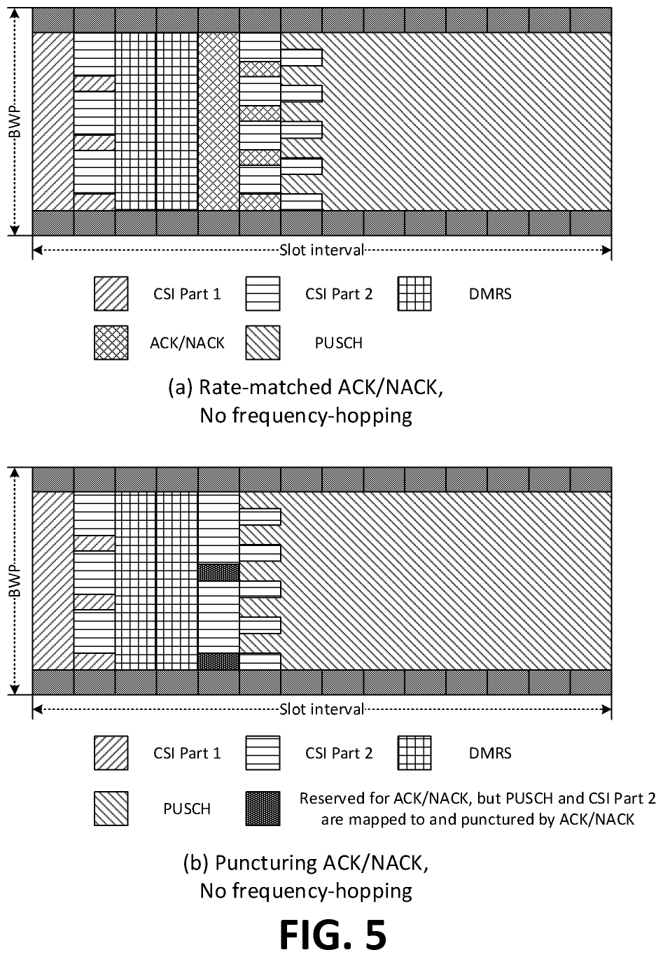

FIG. 5 is a diagram illustrating exemplary multiplexing of UCI on PUSCH that is applicable to a UE and gNB according to an embodiment of the present disclosure. As shown in FIG. 5, an example where ACK/NACK is rate matched around is shown in (a) and another example where ACK/NACK is mapped via puncturing PUSCH data or CSI bits is shown in (b).

From 3GPP TS 38.213 v16.6.0:

If a UE transmits a PUSCH over multiple slots and the UE would transmit a PUCCH with HARQ-ACK and/or CSI information over a single slot that overlaps with the PUSCH transmission in one or more slots of the multiple slots, and the PUSCH transmission in the one or more slots fulfills the conditions in clause 9.2.5 for multiplexing the HARQ-ACK and/or CSI information, the UE multiplexes the HARQ-ACK and/or CSI information in the PUSCH transmission in the one or more slots. The UE does not multiplex HARQ-ACK and/or CSI information in the PUSCH transmission in a slot from the multiple slots if the UE would not transmit a single-slot PUCCH with HARQ-ACK and/or CSI information in the slot in case the PUSCH transmission was absent.

The following is captured in 3GPP TS 38.212 v16.6.0 with regards to rate matching, where the beta offset values are defined for a UE to determine a number of resources for multiplexing HARQ-ACK information and for multiplexing CSI reports in a PUSCH with details defined in section 9.3 of 38.213 V16.6.0:

```
6.3.2.4 Rate matching
6.3.2.4.1 UCI encoded by Polar code
6.3.2.4.1.1 HARQ-ACK
For HARQ-ACK transmission on PUSCH with UL-SCH, the number of coded modulation symbols per
layer for HARQ-ACK transmission, denoted as Q′_{ACK} , is determined as follows:
      ${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{s c}^{UCI} ( l )}{{{\sum }_{r = 0}}^{{C}_{UL - SCH} - 1} {K}_{r}} ⌉ , ⌈ α \cdot {\sum }_{l = {l}_{0}}^{{N}_{symb , all}^{PUSCH} - 1} {M}_{s c}^{UCI} ( l ) ⌉ \}$
where
  - O_{ACK} is the number of HARQ-ACK bits;
  - if O_{ACK} ≥ 360, L_{ACK} =11; otherwise L_{ACK} is the number of CRC bits for HARQ-ACK determined
    according to Clause 6.3.1.2.1 of 3GPP TS 38.212 v16.6.0;
  - β_{offset}^{PUSCH} = β_{offset}^{HARQ-ACK};
  - C_{UL-SCH} is the number of code blocks for UL-SCH of the PUSCH transmission;
  - if the DCI format scheduling the PUSCH transmission includes a CBGTI field indicating that the UE shall
    not transmit the ᵣ-th code block, Kᵣ =0; otherwise, Kᵣ is the ᵣ-th code block size for UL-SCH of the
    PUSCH transmission;
  - M_{sc}^{PUSCH} is the scheduled bandwidth of the PUSCH transmission, expressed as a number of subcarriers;
  - M_{sc}^{PT-RS} (l) is the number of subcarriers in OFDM symbol l that carries PTRS, in the PUSCH transmission;
  - M_{sc}^{UCI} (l) is the number of resource elements that can be used for transmission of UCI in OFDM symbol l,
    for l = 0, 1, 2, ... , N_{symb, all}^{PUSCH} − 1, in the PUSCH transmission and N_{symb, all}^{PUSCH} is the total number of OFDM
    symbols of the PUSCH, including all OFDM symbols used for DMRS;
    - for any OFDM symbol that carries DMRS of the PUSCH, M_{sc}^{UCI} (l) = 0 ;
    - for any OFDM symbol that does not carry DMRS of the PUSCH, M_{sc}^{UCI} (l) = M_{sc} ^{PUSCH} − M_{sc} ^{PT-RS} (l);
  - _{α} is configured by higher layer parameter scaling;
  - l₀ is the symbol index of the first OFDM symbol that does not carry DMRS of the PUSCH, after the first
    DMRS symbol(s), in the PUSCH transmission.
For HARQ-ACK transmission on PUSCH without UL-SCH, the number of coded modulation symbols
per layer for HARQ-ACK transmission, denoted as Q′_{ACK} , is determined as follows:
      ${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{s c}^{UCI} ( l ) ⌉ \}$
where
  - O_{ACK} is the number of HARQ-ACK bits;
  - if O_{ACK} ≥ 360, L_{ACK} =11; otherwise L_{ACK} is the number of CRC bits for HARQ-ACK defined according
    to Clause 6.3.1.2.1 ;;
  - β_{offset}^{PUSCH} = β_{offset}^{HARQ-ACK};
  - M_{sc}^{PUSCH} is the scheduled bandwidth of the PUSCH transmission, expressed as a number of subcarriers;
  - M_{sc}^{PT-RS} (l) is the number of subcarriers in OFDM symbol l that carries PTRS, in the PUSCH transmission;
  - M_{sc}^{UCI} (l) is the number of resource elements that can be used for transmission of UCI in OFDM symbol l,
    for l = 0, 1, 2, ... , N_{symb, all}^{PUSCH} − 1, in the PUSCH transmission and N_{symb, all}^{PUSCH} is the total number of OFDM
    symbols of the PUSCH, including all OFDM symbols used for DMRS;
    - for any OFDM symbol that carries DMRS of the PUSCH, M_{sc}^{UCI} (l) = 0 ;
    - for any OFDM symbol that does not carry DMRS of the PUSCH, M_{sc}^{UCI} (l) = M_{sc}^{PUSCH} − M_{sc}^{PT-RS} (l);
  - l₀ is the symbol index of the first OFDM symbol that does not carry DMRS of the PUSCH, after the first
    DMRS symbol(s), in the PUSCH transmission;
  - _{R} is the code rate of the PUSCH, determined according to Clause 6.1.4.1 of [6, TS38.214];
  - Qₘ is the modulation order of the PUSCH;
  - _{α} is configured by higher layer parameter scaling.
```

Further, in NR R16, PHY prioritization between UL transmissions of different PHY priority index is introduced in 3GPP to address resource conflicts between DG PUSCH and CG PUSCH and conflicts involving multiple CGs and also to address UL data/control and control/control resource collision.

Rel-16 supports a two-level PHY priority index indication of:
Scheduling Request (SR): SR configuration may have a PHY priority index indication as an RRC field in SR resource configuration.
   Note: PHY priority index is only used to let PHY know the priority. MAC will perform prioritization based on LCH priorities.
HARQ-ACK: PHY priority index may be indicated in DL DCI (Formats 1_1 and 1_2) for dynamic assignments and for CG PUSCH the PHY priority index may be indicated by RRC configuration.
PUSCH: For DG PUSCH, PHY priority index may be indicated in UL DCI (Formats 0_1 and 0_2), and for CG PUSCH, the PHY priority index may be indicated by CG PUSCH configuration.
A-periodic and semi-persistent CSI on PUSCH: PHY priority index may be indicated in UL DCI (Formats 0_1 and 0_2).
Low PHY priority index is assumed for periodic and semi-persistent CSI on PUCCH, periodic and semi-persistent SRS and when PHY priority index is not indicated.
A periodic SRS is always of low priority.

PHY priority index 0 may be defined as low priority and PHY priority index 1 is defined as high priority.

In Rel-16, UCI may be multiplexed in a PUCCH or a PUSCH only if PHY priority index of UCI and the PHY priority index of PUCCH or PUSCH is the same. Certain combinations of multiplexing UCI and PUSCH of different priorities are expected to be supported in Rel-17, for example, multiplexing a high-priority HARQ-ACK and a low-priority HARQ-ACK into a PUCCH, multiplexing a low-priority HARQ-ACK in a high-priority PUSCH, etc.

The Rel-16 intra-UE PHY prioritization first resolves time-overlapping for PUCCH and/or PUSCH transmissions for same PHY priority, then time-overlapping between priorities is resolved, where the lower-priority PUCCH/PUSCH is not transmitted if it is time-overlapping with a higher-priority PUCCH/PUSCH transmission. Here, it should be emphasized that UE does not resolve time-overlapping for PUCCH/PUSCH transmissions of high-priority before resolving time-overlapping between priorities. This means that UE will cancel a low-priority PUCCH/PUSCH transmission that time-overlaps with a high-priority PUCCH but not with a high-priority PUSCH that time-overlap with the high-priority PUCCH although the high-priority PUCCH will not be sent since UCI would be multiplexed on the high-priority PUSCH.

Rel-16 also supports 2 HARQ codebooks and both can be slot/sub-slot based or can be different (Each codebook is separately configured).
Two HARQ-ACK CodeBooks (CBs) can be configured
   1st HARQ-ACK CB↔PHY priority index 0
   2nd HARQ-ACK CB↔PHY priority index 1
Two PUCCH configurations
   1st PUCCH↔1st HARQ-ACK CB
   2nd PUCCH↔2nd HARQ-ACK CB
   Each PUCCH can be slot or sub-slot configured
Two UCI-OnPUSCH (one per HARQ-ACK codebook)
   i.e., Beta-factor for HARQ-ACK (and CSI) per PHY priority index

Further, in NR up to Release 17, 2 codewords are supported for PDSCH transmission and only single codeword is supported for PUSCH transmission. Up to 4 transmission layers are supported in uplink while up to 8 transmission layers are supported in downlink. When 2 codewords are used in downlink, the number of transmission layers shall be greater than 4. When the number of transmission layers is less than or equal to 4, a single codeword may be used in the downlink in NR up to Rel-17. The codeword to layer mapping assumed in NR is shown in Table 6.

TABLE 6
Codeword-to-layer mapping for spatial multiplexing.

| | | |
|---|---|---|
| Number | Number | Codeword-to-layer mapping |
| of layers | of codewords | i = 0, 1, . . . , M_{symb}^{layer} − 1 |

| | | | |
|---|---|---|---|
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 3 | 1 | x⁽⁰⁾(i) = d⁽⁰⁾(3i) | M_{symb}^{layer} = M_{symb}⁽⁰⁾/3 |
| | | x⁽¹⁾(i) = d⁽⁰⁾(3i + 1) | |
| | | x⁽²⁾(i) = d⁽⁰⁾(3i + 2) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| 5 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾/3 |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(3i) | M_{symb}^{layer} = M_{symb}⁽⁰⁾/3 = |
| | | x⁽¹⁾(i) = d⁽⁰⁾(3i + 1) | M_{symb}⁽¹⁾/3 |
| | | x⁽²⁾(i) = d⁽⁰⁾(3i + 2) | |
| | | x⁽³⁾(i) = d⁽¹⁾(3i) | |
| | | x⁽⁴⁾(i) = d⁽¹⁾(3i + 1) | |
| | | x⁽⁵⁾(i) = d⁽¹⁾(3i + 2) | |
| 7 | 2 | x⁽⁰⁾(i) = d⁽¹⁾(3i) | M_{symb}^{layer} = M_{symb}⁽⁰⁾/3 = |
| | | x⁽¹⁾(i) = d⁽⁰⁾(3i + 1) | M_{symb}⁽¹⁾/4 |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = M_{symb}⁽⁰⁾/4 = |
| | | x⁽¹⁾(i) = d⁽⁰⁾(4i + 1) | M_{symb}⁽¹⁾/4 |
| | | x⁽²⁾(i) = d⁽⁰⁾(4i + 2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

Further, in NR Release 16, PUSCH repetition enhancements were made for both PUSCH type A and type B for the purposes of further latency reduction (i.e., for Rel-16 URLLC feature).

In NR Rel-15, the number of aggregated slots for both dynamic grant and configured grant Type 2 may be RRC configured. In NR Rel-16, this was enhanced so that the number of repetitions can be dynamically indicated, i.e. the number of repetitions can be changed from one PUSCH scheduling occasion to the next via DCI indication. That is, in addition to the starting symbol S, and the length of the PUSCH L, a number of nominal repetitions K is signaled as part of time-domain resource allocation (TDRA). Furthermore, the maximum number of aggregated slots was increased to K=16 to account for DL heavy TDD patterns. Inter-slot and intra-slot hopping can be applied for PUSCH repetition Type A. The number of repetitions K is nominal since some slots may be DL slots and the DL slots are then skipped for PUSCH transmissions. So, K is the maximal number of repetitions possible.

PUSCH repetition Type B applies to both dynamic and configured grants. Type B PUSCH repetition can cross the slot boundary in NR Rel-16. When scheduling a transmission with PUSCH repetition Type B, in addition to the starting symbol S, and the length of the PUSCH L, a number of nominal repetitions K is signaled as part of time-domain resource allocation (TDRA) in NR Rel-16. Inter-slot frequency hopping and inter-repetition frequency hopping can be configured for Type B repetition. To determine the actual time domain allocation of Type B PUSCH repetitions, a two-step process is used:
Allocate K nominal repetitions of length L back-to-back (adjacent in time), ignoring slot boundaries and TDD pattern.
If a nominal repetition crosses a slot boundary or occupies symbols not usable for UL transmission (e.g. UL/DL switching points due to TDD pattern), the offending nominal repetition may be split into two or more shorter actual repetitions. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot.

Although the term ‘PUSCH repetition’ is used in this document, it can be interchangeably used with other terms such as ‘PUSCH transmission occasion’.

In NR Rel-15/16, when PUSCH is repeated according to PUSCH repetition Type A, the PUSCH is limited to a single transmission layer.

In Rel-15, slot aggregation, also known as PUSCH repetition Type A in Rel-16, has been supported, where number of slot-based PUSCH repetitions is semi-statically configured. In Rel-16, the number of PUSCH repetitions can be dynamically indicated with DCI.

In Rel-15/16, PUSCH repetition Type A allows a single repetition in each slot, with each repetition occupying the same symbols. In some TDD UL/DL configurations, there are a small number of contiguous UL slots in a radio frame. In this scenario, multiple PUSCH repetitions do not have to be in contiguous slots. However, the DL slots are counted as slots for PUSCH repetitions.

Two enhancements of PUSCH repetition Type A were agreed as part of the Rel-17 NR coverage enhancement work item (WI) in 3GPP. The agreement is given below:
PUSCH repetition Type A
   Opt.1: Increasing the maximum number of repetitions up to a number to be determined during the course of the work.
   Opt.2: The number of repetitions counted on the basis of available UL slots.

Regarding Option 2 (Opt.2), definition of available slot was discussed in 3GPP. Determination of available slot is still being discussed in 3GPP RAN1.

In NR, only one codeword (or one transport block) up to 4 layers can be used for transmission on PUSCH scheduled by dynamic grant or configured grant. When a UE is equipped with more than 4 transmit antennas and base station has more than 4 receive antennas, in some scenarios there can be more than 4 layers. To support more than 4 layers in these scenarios, more than one codewords are needed.

Further, in some other scenarios, a UE may be equipped with two or more antenna panels, each sending data towards a different reception point (RP). In this case, a separate codeword may be used for PUSCH transmission from each antenna panel towards a RP such that the codeword can be decoded at the respective RP. Thus, multiple codewords are needed. How to support multiple codewords in uplink PUSCH transmission is a problem.

Furthermore, how to transmit UCI on the layers of different codewords needs to be considered in case of UCI only on PUSCH with 2 codewords assumed and in case of UCI multiplexed on PUSCH with data from multiple codewords. On top of above, when multiple codewords are transmitted on PUSCH, some of the codeword with higher priority may need to be repeated or repeated with more times compared to the codewords with lower priority and different types of PUSCH repetitions should be considered as well.

Some embodiments of the present disclosure provide methods on how to support multiple codewords transmission in PUSCH in NR and how to transmit UCI on PUSCH when multiple codewords are transmitted, in the following aspects:
Configuration and signaling of PUSCH transmission with 2 codewords in NR;
Multiplexing of UCI on PUSCH with multiple codewords without UL-SCH data;
Multiplexing UCI on PUSCH with data from multiple codewords with UL-SCH data; and
Multiple codewords transmission on PUSCH with repetition.

Some embodiments of the present disclosure provide methods on:
how to support multiple codewords transmission in PUSCH in NR,
   UE capability report and in which case the multiple codewords shall be supported;
   Mechanism of supporting multiple codeword transmission on PUSCH for DG or CG Type 2 PUSCH;
   Mechanism of supporting multiple codeword transmission on PUSCH for CG Type 2 PUSCH;
   Mechanism of supporting multiple codeword transmission on PUSCH on multiple TRPs;
   Maximum number of codewords control for PUSCH transmissions;
how to transmit UCI on PUSCH with multiple codewords;
   UCI multiplexing on PUSCH with multiple codewords, without UL-SCH data;
   UCI multiplexing on PUSCH with multiple codewords, with UL-SCH data;
how to support different types of repetition of PUSCH with multiple codewords and whether different codewords can be repeated with different times depending on the priority of the codeword.

In some embodiments of the present disclosure, the term “multiple codewords” may refer to 2 or more codewords transmission on one PUSCH channel, which can also be viewed as multiple TBs, since one codeword corresponds to one TB. The multiple codewords may be transmitted simultaneously in spatial domain, while sharing the same time-frequency resources. For instance, if two codewords are transmitted on one PUSCH, one codeword may be mapped to a first set of one or more MIMO layers, the other codeword may be mapped to a second set of one or more MIMO layers, where the first and second sets do not overlap (i.e., do not share a same MIMO layer).

In some embodiments of the present disclosure, the term “DG PUSCH” may refer to the dynamic grant scheduled PUSCH, where a PUSCH transmission is scheduled by a corresponding UL scheduling DCI. The term “CG PUSCH” may refer to the PUSCH scheduled by configured grant, where a PUSCH is transmitted without a corresponding UL scheduling DCI, after the configured grant configuration is activated.

In some embodiments of the present disclosure, the term “HP” may refer to high physical layer priority, while “LP” may refer to low physical layer priority. In some embodiments of the present disclosure, the terms “codeword (CW)” and “TB” may be exchangeable where a TB may refer to the unencoded raw information bits while a CW may refer to the corresponding encoded bits.

Some embodiments of the present disclosure provide methods on how to report the capability of multiple-codeword transmission on PUSCH and how to define the mechanism of multiple-codeword transmission.

In some embodiments, multiple-codeword transmission on PUSCH should be an optional feature for a UE, and network should be notified in the UE capability signaling on whether the UE supports multiple codewords on PUSCH. This makes it possible for network to know whether a multiple codeword transmission on PUSCH can be enabled or not for a UE based on the UE capability reported.

In some embodiments, a UE should report to the gNB its capability of supporting multiple codeword transmission on PUSCH after RRC connection. After receiving the capability report from the given UE, the gNB may choose to configure the PUSCH transmission of this UE with single-codeword only, or multiple (e.g., up to two) codewords transmission, for example, using UE-specific DL signaling. In some embodiments, the UE-specific signaling may be an RRC configuration.

In some embodiments, the capability of supporting multiple-codeword transmission on CG PUSCH and DG PUSCH may be separately reported from the UE to the gNB.

In some embodiments, multiple-codeword transmission on PUSCH scheduled by CG (Type 1 and/or Type 2) is not supported in the specification, i.e., it's not supported regardless of UE capability. In this case, a UE only needs to report the capability of supporting multiple codeword transmission on DG scheduled PUSCH.

In some embodiments, for DG PUSCH or Type 2 CG PUSCH, at least one of following configurations of a single codeword transmission may be provided in DCI format 0_1 or 0_2:
Modulation and coding scheme (MCS);
New data indicator (NDI);
Redundancy version (RV).

In some embodiments, for DG PUSCH, the parameters in UL DCI (e.g., DCI format 0_1 or 0_2) are provided for one-time transmission of the corresponding PUSCH. For Type 2 CG PUSCH, the UL DCI that provides the transmission parameters may be an activation DCI where the CG configuration is activated for recurring (periodical) PUSCH transmission, until the CG configuration is deactivated by another DCI. For CG PUSCH, the parameters in the activation UL DCI (e.g., DCI format 0_1 or 0_2) may be used by each of the recurring PUSCH.

In some embodiments, whether separate configurations should be provided for different codewords may be specified and/or whether multiple codewords are supported by network may also be indicated by the network.

In some embodiments, for DG PUSCH and/or Type 2 CG PUSCH, if multiple codewords are enabled or configured, one or more of the following parameters may be configured in uplink DCI (e.g., DCI format 0_1 or 0_2) for each one or each subset of the multiple TBs to support multiple codewords transmission:
Modulation and coding scheme;
New data indicator; and
Redundancy version.

In some embodiments, legacy DCI format (e.g., DCI format 0_1 or DCI format 0_2) may be used with additional DCI fields comprised for the additional codewords. In other words, one set of ‘Modulation and coding scheme,’ ‘New data indicator’, and ‘Redundancy version’ fields may be configured in the uplink DCI for each codeword to be transmitted on PUSCH.

In some embodiments, a new DCI format may be used with additional DCI fields comprised for transmission of the additional codewords. That is, the new DCI format may contain fields that signal the transmission parameters for two or more codewords.

In some embodiments, multiple PDCCH transmissions may be used to schedule multiple TB transmission. For example, when 4 codewords are supported on PUSCH, a first PDCCH may be used to schedule some parameters of the first 2 codewords, while a second PDCCH may be used to schedule the last 2 codewords.

In some embodiments, for PUSCH scheduled by CG Type 1, one or more of the following parameters may be configured in RRC for the 2nd or more TBs to support multiple codewords transmission:
MCS index;
MCS table;
Information of precoding and number of layers; and
SRS resource indicator (SRI).

In some embodiments, 3 parameters may be defined in the ConfiguredGrantConfig for the transmission of the 2nd codeword (i.e., codeword carrying 2nd TB) on PUSCH scheduled by CG Type 1.

precodingAndNumberOfLayers2ndTB: provides precoding information and number of layers for the 2nd codeword (i.e., codeword carrying 2nd TB) transmission on PUSCH.

srs-ResourceIndicator2ndTB: Indicates the SRS resource to be used for the 2nd codeword (i.e., codeword carrying 2nd TB).

mcsAndTBS2ndTB. The MCS index to determine modulation order, target code rate and TB size for the 2nd codeword (i.e., codeword carrying 2nd TB) transmission.

| | |
|---|---|
| ConfiguredGrantConfig ::= | SEQUENCE { |

...

| | |
|---|---|
| rrc-ConfiguredUplinkGrant | SEQUENCE { |

| | |
|---|---|
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |

```
    precodingAndNumberOfLayers2ndTB INTEGER (0..63),
    srs-ResourceIndicator2ndTB INTEGER (0..15)
OPTIONAL, -- Need R
    mcsAndTBS2ndTB INTEGER (0..31),
```

| | |
|---|---|
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs-1), |

```
    ...,
    [[
```

| | |
|---|---|
| pusch-RepTypeIndicator-r16 | ENUMERATED {pusch-RepTypeA,pusch-RepTypeB} |

OPTIONAL, -- Need M

| | |
|---|---|
| frequencyHoppingPUSCH-RepTypeB-r16 | ENUMERATED {interRepetition, interSlot} |

OPTIONAL, -- Cond RepTypeB

| | |
|---|---|
| timeReferenceSFN-r16 | ENUMERATED {sfn512} |

```
OPTIONAL -- Need S
    ]]
  }
OPTIONAL, -- Need R
  ...
}
```

In some embodiments, maximum number of codewords transmitted on a PUSCH supported by the network may be indicated by RRC signaling. For example, a maxNrofCodeWordsScheduledByDCI-0-1 field (for DCI format 0_1), and/or a maxNrofCodeWordsScheduledByDCI-0-2 field (for DCI format 0_2) may be defined in PUSCH-Config IE to indicate the maximum number of codewords support for PUSCH transmission scheduled by dynamic grant. In the examples provided in this embodiment, the values ‘n1’ and ‘n2’ respectively denote 1 and 2 maximum number of codewords for PUSCH.

maxNrofCodeWordsScheduledByDCI-0-1 ENUMERATED {n1, n2} OPTIONAL, -- Need R
maxNrofCodeWordsScheduledByDCI-0-2 ENUMERATED {n1, n2} OPTIONAL, -- Need R

For another example, a maxNrofCodeWords field may be defined in PUSCH-Config IE to indicate the maximum number of codewords support for any PUSCH transmission in the cell, i.e., scheduled by either dynamic grant of configured grant.

maxNrofCodeWords ENUMERATED {n1, n2} OPTIONAL, -- Need R

As another example, a maxNrofCodeWordsScheduledByDCI-0-1 field (for DCI format 0_1), and/or a maxNrofCodeWordsScheduledByDCI-0-2 field (for DCI format 0_2), may be defined in PUSCH-Config IE to indicate the maximum number of codewords supported for PUSCH transmission scheduled dynamic grant or by configured grant type 2. Further, another field maxNrofCodeWordsScheduledByRRC may be defined in PUSCH-Config IE to indicate the maximum number of codewords support for PUSCH transmission scheduled by configured grant type 1.

| | |
|---|---|
| maxNrofCodeWordsScheduledByDCI-0-1 | ENUMERATED {n1, n2} OPTIONAL, -- Need R |
| maxNrofCodeWordsScheduledByDCI-0-2 | ENUMERATED {n1, n2} OPTIONAL, -- Need R |
| maxNrofCodeWordsScheduledByRRC | ENUMERATED {n1, n2} OPTIONAL, -- Need R |

For another example, a maxNrofCodeWords field may be defined in ConfiguredGrantConfig IE to indicate the maximum number of codewords support for PUSCH transmission scheduled configured grant.

maxNrofCodeWords ENUMERATED {n1, n2} OPTIONAL, -- Need R

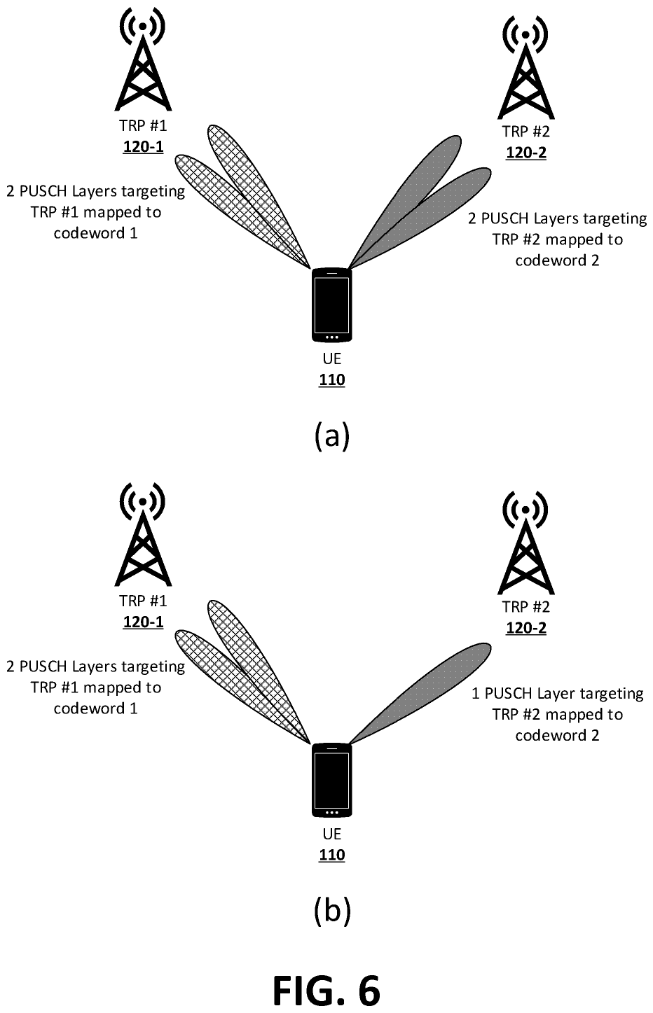

In some embodiments, multiple codeword PUSCH transmission may be targeted towards multiple Transmission Reception Points (TRPs). A first example is depicted in (a) of FIG. 6 where each transmitted PUSCH codeword contains transmission layers targeted towards different TRPs. As shown in (a) of FIG. 6, 2 PUSCH layers targeted towards the first TRP are mapped to a first PUSCH codeword and another 2 PUSCH layers targeted towards the second TRP are mapped to a second PUSCH codeword. All PUSCH layers may be transmitted in the same time-frequency resources (e.g., same resource elements). This embodiment may be applicable to both DG PUSCH and Type 2 CG PUSCH). The multiple-codeword PUSCH transmission that is targeted towards multiple TRPs may be scheduled by one DCI from one TRP or one DCI from multiple TRPs. For example, different TRPs may be associated to different SRS resource sets, and in this case, different TRPs may also correspond to the different codewords transmission.

In some embodiments, at least one of the following parameters may be signaled in the uplink DCI (e.g., DCI with DCI format 0_1 or 0_2) for the first codeword:
Modulation and coding scheme for the first codeword or first TB (MCS 1) may be indicated to the UE via a 1^{st} ‘Modulation and coding scheme’ field in the uplink DCI.
Redundancy version for the first codeword or first TB (RV 1) may be indicated to the UE via a first ‘Redundancy version’ field in the uplink DCI.
The TPMI and the number of PUSCH layers corresponding to the first codeword or first TB are indicated to the UE via a first ‘Precoding information and number of layers’ field in the uplink DCI. Note that this field is indicated to the UE (i.e., this field is present in uplink DCI) when the UE is scheduled to transmit Codebook based PUSCH transmission. This field is not indicated to the UE (i.e., this field is not present in the uplink DCI) when the UE is scheduled to transmit non-Codebook based PUSCH transmission.
The SRS resource(s) corresponding to the PUSCH layers mapped to the first codeword may be indicated to the UE via the first ‘SRS resource indicator’ field.
   In Codebook based PUSCH transmission, a single SRS resource may be indicated by the first ‘SRS resource indicator’ field. The PUSCH layers mapped to the first codeword may be spatially related to the most recent SRS transmission in the SRS resource indicated by the first ‘SRS resource indicator’ field.
   In non-Codebook based PUSCH transmission, one or more SRS resources may be indicated by the first ‘SRS resource indicator’ field. The PUSCH layers mapped to the first codeword may be transmitted using the same antenna ports as the SRS port(s) in the SRS resource(s) indicated by the first ‘SRS resource indicator’ field. Assuming non-Codebook based PUSCH transmission in the example of (a) of FIG. 6, two SRS resources would be indicated by the first ‘SRS resource indicator’ field whose SRS port(s) are used to transmit the two PUSCH layers mapped to codeword 1.

As for the second codeword, at least one of the following parameters may be signaled in the uplink DCI (e.g., DCI with DCI format 0_1 or 0_2):
Modulation and coding scheme for the second codeword or second TB (MCS 2) may be indicated to the UE via a 2^{nd} ‘Modulation and coding scheme’ field in the uplink DCI.
Redundancy version for the second codeword or second TB (RV 2) may be indicated to the UE via a second ‘Redundancy version’ field in the uplink DCI.
The TPMI and the number of PUSCH layers corresponding to the second codeword or second TB may be indicated to the UE via a second ‘Precoding information and number of layers’ field in the uplink DCI. Note that this field may be indicated to the UE (i.e., this field is present in uplink DCI) when the UE is scheduled to transmit Codebook based PUSCH transmission. This field may be not indicated to the UE (i.e., this field is not present in the uplink DCI) when the UE is scheduled to transmit non-Codebook based PUSCH transmission
The SRS resource(s) corresponding to the PUSCH layers mapped to the second codeword may be indicated to the UE via the second ‘SRS resource indicator’ field.
   In Codebook based PUSCH transmission, a single SRS resource may be indicated by the second ‘SRS resource indicator’ field. The PUSCH layers mapped to the second codeword may be spatially related to the most recent SRS transmission in the SRS resource indicated by the second ‘SRS resource indicator’ field.
   In non-Codebook based PUSCH transmission, one or more SRS resources may be indicated by the second ‘SRS resource indicator’ field. The PUSCH layers mapped to the second codeword may be transmitted using the same antenna ports as the SRS port(s) in the SRS resource(s) indicated by the second ‘SRS resource indicator’ field.
      Assuming non-Codebook based PUSCH transmission in the example of (a) of FIG. 6, two SRS resources would be indicated by the second ‘SRS resource indicator’ field whose SRS port(s) may be used to transmit the two PUSCH layers mapped to codeword 1.

In some embodiments, the number of PUSCH layers mapped to the two or more codewords may be same or different. For example, (b) of FIG. 6 shows the case where the number of PUSCH layers mapped to the two codewords are different. In (b) of FIG. 6, 2 PUSCH layers targeted towards the first TRP are mapped to a first PUSCH codeword and 1 PUSCH layer targeted towards the second TRP are mapped to a second PUSCH codeword.

In some embodiments, for the case when 2 codewords are supported, the two SRS resource indicator fields may indicate SRS resource(s) configured in two different SRS resource sets configured to the UE. That is, the first SRS resource indicator field may indicate SRS resource(s) from the first configured SRS resource set, and the second SRS resource indicator field may indicate SRS resource(s) from the second configured SRS resource set.

Furthermore, the term “TRP” may not be captured in 3GPP specifications. Instead, a TRP may be represented by any one of an SRS resource set configuration (e.g., SRS resource set 1 represents TRP 1), a ‘SRS resource indicator’ field (e.g., 1st ‘SRS resource indicator’ field represents TRP 1), a ‘Precoding information and number of layers’ field (e.g., 1^{st} ‘Precoding information and number of layers’ field indicates TRP 1).

For example, following parameters may be separately configured in DCI format 0_1 for 2^{nd} TB transmission on PUSCH. In the example below, RRC parameter maxNrofCodeWordsScheduledByDCI-0-1 indicates whether the transmission parameters for the 2^{nd} TB are present in DCI format 0_1 or not. If maxNrofCodeWordsScheduledByDCI-0-1 is absent or has value ‘1’, then transmission parameters are provided for the first TB only. Otherwise (for example, maxNrofCodeWordsScheduledByDCI-0-1 has value ‘2’), transmission parameters are provided for both the first and second TBs, respectively. The new parameters provided for the second TB are highlighted with underlines in the text below:

```
The following information may be transmitted by means of the DCI format 0_1 with
CRC scrambled by C-RNTI or CS-RNTI or SP-CSI-RNTI or MCS-C-RNTI:
. . .
For transport block 1:
  - Modulation and coding scheme - 5 bits as defined in Clause 6.1.4.1 of [6, TS 38.214]
  - New data indicator - 1 bit if the number of scheduled PUSCH indicated by the Time domain resource
    assignment field is 1; otherwise 2, 3, 4, 5, 6, 7 or 8 bits determined based on the maximum number of
    schedulable PUSCH among all entries in the higher layer parameter pusch-
    TimeDomainAllocationListForMultiPUSCH, where each bit corresponds to one scheduled PUSCH as
    defined in clause 6.1.4 in [6, TS 38.214].
  - Redundancy version — number of bits determined by the following:
    - 2 bits as defined in Table 7.3.1.1.1-2 if the number of scheduled PUSCH indicated by the Time
        domain resource assignment field is 1;
    - otherwise 2, 3, 4, 5, 6, 7 or 8 bits determined by the maximum number of schedulable PUSCHs
        among all entries in the higher layer parameter pusch-TimeDomainAllocationListForMultiPUSCH,
        where each bit corresponds to one scheduled PUSCH as defined in clause 6.1.4 in [6, TS 38.214] and
        redundancy version is determined according to Table 7.3.1.1.2-34.
    . . .
  -  $SRS resource indicator - ⌈ {log}_{2} ( {\sum }_{k = 1}^{min \{ {L}_{ma x} , {N}_{SRS} \}} ( \begin{matrix}{N}_{SRS} \\ k\end{matrix} ) ) ⌉ or ⌈ {log}_{2} ( {N}_{SRS} ) ⌉ bits , where {N}_{SRS} is the number$
    of configured SRS resources in the 1st SRS resource set configured by higher layer parameter srs-
    ResourceSetToAddModList, and associated with the higher layer parameter usage of value 'codeBook' or
    ′nonCodeBook′,
    -  $⌈ {log}_{2} ( {\sum }_{k = 1}^{min \{ {L}_{ma x} , {N}_{SRS} \}} ( \begin{matrix}{N}_{SRS} \\ k\end{matrix} ) ) ⌉ bits according to Tables 7.3 \text{.1} \text{.1} \text{.2} - 28 / 29 / 30 / 31 if the higher layer$
        parameter txConfig = nonCodebook, where N_{SRS} is the number of configured SRS resources in the
        1^{st} SRS resource set configured by higher layer parameter srs-ResourceSetToAddModList, and
        associated with the higher layer parameter usage of value ′nonCodeBook′ and
      - if UE supports operation with maxMIMO-Layers and the higher layer parameter maxMIMO-
        Layers of PUSCH-ServingCellConfig of the serving cell is configured, Lₘₐₓ is given by that
        parameter
      - otherwise, Lₘₐₓ is given by the maximum number of layers for PUSCH supported by the UE for
        the serving cell for non-codebook based operation.
    - ┌log ₂ (N_{SRS} )┐ bits according to Tables 7.3.1.1.2-32, 7.3.1.1.2-32A and 7.3.1.1.2-32B if the higher
      layer parameter txConfig = codebook, where N_{SRS} is the number of configured SRS resources in the
      1^{st} SRS resource set configured by higher layer parameter srs-ResourceSetToAddModList, and
      associated with the higher layer parameter usage of value ′codeBook′.
  - Precoding information and number of layers - number of bits determined by the following:
    - 0 bits if the higher layer parameter txConfig = nonCodeBook,
    - 0 bits for 1 antenna port and if the higher layer parameter txConfig = codebook;
    - 4, 5, or 6 bits according to Table 7.3.1.1.2-2 for 4 antenna ports, if txConfig = codebook, ul-
        FullPowerTransmission is not configured or configured to fullpowerMode2 or configured to
        fullpower, and according to whether transform precoder is enabled or disabled, and the values of
        higher layer parameters maxRank, and codebookSubset;
    - 4 or 5 bits according to Table 7.3.1.1.2-2A for 4 antenna ports, if txConfig = codebook, ul-
        FullPowerTransmission = fullpowerMode1, maxRank=2, transform precoder is disabled, and
        according to the values of higher layer parameter codebookSubset;
    - 4 or 6 bits according to Table 7.3.1.1.2-2B for 4 antenna ports, if txConfig = codebook, ul-
        FullPowerTransmission = fullpowerMode1, maxRank=3 or 4, transform precoder is disabled, and
        according to the values of higher layer parameter codebookSubset;
    - 2, 4, or 5 bits according to Table 7.3.1.1.2-3 for 4 antenna ports, if txConfig = codebook, ul-
        FullPowerTransmission is not configured or configured to fullpowerMode2 or configured to
        fullpower, and according to whether transform precoder is enabled or disabled, and the values of
        higher layer parameters maxRank, and codebookSubset;
    - 3 or 4 bits according to Table 7.3.1.1.2-3A for 4 antenna ports, if txConfig = codebook, ul-
        FullPowerTransmission = fullpowerMode1, maxRank=1, and according to whether transform
        precoder is enabled or disabled, and the values of higher layer parameter codebookSubset,
    - 2 or 4 bits according to Table7.3.1.1.2-4 for 2 antenna ports, if txConfig = codebook, ul-
        FullPowerTransmission is not configured or configured to fullpowerMode2 or configured to
        fullpower, and according to whether transform precoder is enabled or disabled, and the values of
        higher layer parameters maxRank and codebookSubset;
    - 2 bits according to Table 7.3.1.1.2-4A for 2 antenna ports, if txConfig = codebook, ul-
        FullPowerTransmission = fullpowerMode1, transform precoder is disabled, maxRank=2, and
        codebookSubset=nonCoherent;
    - 1 or 3 bits according to Table7.3.1.1.2-5 for 2 antenna ports, if txConfig = codebook, ul-
        FullPowerTransmission is not configured or configured to fullpowerMode2 or configured to
        fullpower, and according to whether transform precoder is enabled or disabled, and the values of
        higher layer parameters maxRank and codebookSubset,
    - 2 bits according to Table 7.3.1.1.2-5A for 2 antenna ports, if txConfig = codebook, ul-
        FullPowerTransmission = fullpowerMode1, maxRank=1, and according to whether transform
        precoder is enabled or disabled, and the values of higher layer parameter codebookSubset,
  For transport block 2 (only present if maxNrofCodeWordsScheduledByDCI-0-1 equals 2):
  - Modulation and coding scheme - 5 bits as defined in Clause 6.1.4.1 of [6, TS 38.214]
  - New data indicator - 1 bit if the number of scheduled PUSCH indicated by the Time domain resource
      assignment field is 1; otherwise 2, 3, 4, 5, 6, 7 or 8 bits determined based on the maximum number of
      schedulable PUSCH among all entries in the higher layer parameter pusch-
      TimeDomainAllocationListForMultiPUSCH, where each bit corresponds to one scheduled PUSCH as
      defined in clause 6.1.4 in [6, TS 38.214].
  - Redundancy version — number of bits determined by the following:
    - 2 bits as defined in Table 7.3.1.1.1-2 if the number of scheduled PUSCH indicated by the Time
        domain resource assignment field is 1;
    - otherwise 2, 3, 4, 5, 6, 7 or 8 bits determined by the maximum number of schedulable PUSCHs
        among all entries in the higher layer parameter pusch-TimeDomainAllocationListForMultiPUSCH,
        where each bit corresponds to one scheduled PUSCH as defined in clause 6.1.4 in [6, TS 38.214] and
        redundancy version is determined according to Table 7.3.1.1.2-34.
  - $SRS resource indicator - ⌈ {log}_{2} ( {\sum }_{k = 1}^{min \{ {L}_{ma x} , {N}_{SRS} \}} ( \begin{matrix}{N}_{SRS} \\ k\end{matrix} ) ) ⌉ or ⌈ {log}_{2} ( {N}_{SRS} ) ⌉ bits , where {N}_{SRS} is the number$
    of configured SRS resources in the 2nd SRS resource set configured by higher layer parameter srs-
    ResourceSetToAddModList, and associated with the higher layer parameter usage of value 'codeBook' or
    ′nonCodeBook′,
    - $⌈ {log}_{2} ( {\sum }_{k = 1}^{min \{ {L}_{ma x} , {N}_{SRS} \}} ( \begin{matrix}{N}_{SRS} \\ k\end{matrix} ) ) ⌉ bits according to Tables 7.3 \text{.1} \text{.1} \text{.2} - 28 / 29 / 30 / 31 if the higher layer$
        parameter txConfig = nonCodebook, where N_{SRS} is the number of configured SRS resources in the
        2^{nd} SRS resource set configured by higher layer parameter srs-ResourceSetToAddModList, and
        associated with the higher layer parameter usage of value 'nonCodeBook' and
    - if UE supports operation with maxMIMO-Layers and the higher layer parameter maxMIMO-
        Layers of PUSCH-ServingCellConfig of the serving cell is configured, Lₘₐₓ is given by that
        parameter
    - otherwise, Lₘₐₓ is given by the maximum number of layers for PUSCH supported by the UE for
        the serving cell for non-codebook based operation.
  - ┌ log₂ (N_{SRS} )┐bits according to Tables 7.3.1.1.2-32. 7.3.1.1.2-32A and 7.3.1.1.2-32B if the higher
      layer parameter txConfig = codebook, where N_{SRS} is the number of configured SRS resources in the
      2^{nd} SRS resource set configured by higher layer parameter srs-ResourceSetToAddModList, and
      associated with the higher layer parameter usage of value ′codeBook′.
  - Precoding information and number of layers - number of bits determined by the following:
    - 0 bits if the higher layer parameter txConfig = nonCodeBook;
    - 0 bits for 1 antenna port and if the higher layer parameter txConfig = codebook;
    - 4, 5, or 6 bits according to Table 7.3.1.1.2-2 for 4 antenna ports, if txConfig = codebook, ul-
        FullPowerTransmission is not configured or configured to fullpowerMode2 or configured to
        fullpower, and according to whether transform precoder is enabled or disabled, and the values of
        higher layer parameters maxRank, and codebookSubset,
    - 4 or 5 bits according to Table 7.3.1.1.2-2A for 4 antenna ports, if txConfig = codebook, ul-
      FullPowerTransmission = fullpowerMode1, maxRank=2, transform precoder is disabled, and
      according to the values of higher layer parameter codebookSubset;
    - 4 or 6 bits according to Table 7.3.1.1.2-2B for 4 antenna ports, if txConfig = codebook, ul-
      FullPowerTransmission = fullpowerMode1, maxRank=3 or 4, transform precoder is disabled, and
      according to the values of higher layer parameter codebookSubset;
    - 2, 4, or 5 bits according to Table 7.3.1.1.2-3 for 4 antenna ports, if txConfig = codebook, ul-
      FullPowerTransmission is not configured or configured to fullpowerMode2 or configured to
      fullpower, and according to whether transform precoder is enabled or disabled, and the values of
      higher layer parameters maxRank, and codebookSubset;
    - 3 or 4 bits according to Table 7.3.1.1.2-3A for 4 antenna ports, if txConfig = codebook, ul-
      FullPowerTransmission = fullpowerMode1, maxRank=1, and according to whether transform
      precoder is enabled or disabled, and the values of higher layer parameter codebookSubset,
    - 2 or 4 bits according to Table7.3.1.1.2-4 for 2 antenna ports, if txConfig = codebook, ul-
      FullPowerTransmission is not configured or configured to fullpowerMode2 or configured to
      fullpower, and according to whether transform precoder is enabled or disabled, and the values of
      higher layer parameters maxRank and codebookSubset;
    - 2 bits according to Table 7.3.1.1.2-4A for 2 antenna ports, if txConfig = codebook, ul-
      FullPowerTransmission = fullpowerMode1, transform precoder is disabled, maxRank=2, and
      codebookSubset=nonCoherent;
    - 1 or 3 bits according to Table7.3.1.1.2-5 for 2 antenna ports, if txConfig = codebook, ul-
      FullPowerTransmission is not configured or configured to fullpowerMode2 or configured to
      fullpower, and according to whether transform precoder is enabled or disabled, and the values of
      higher layer parameters maxRank and codebookSubset;
    - 2 bits according to Table 7.3.1.1.2-5A for 2 antenna ports, if txConfig = codebook, ul-
      FullPowerTransmission = fullpowerMode1, maxRank=1, and according to whether transform
      precoder is enabled or disabled, and the values of higher layer parameter codebookSubset;
. . .
```

Similar to the example above, the set of transmission parameters may be separately provided by DCI fields in DCI format 0_2 for 2nd TB transmission on PUSCH. Further, in a similar manner as maxNrofCodeWordsScheduledByDCI-0-1, RRC parameter maxNrofCodeWordsScheduledByDCI-0-2 configures if the transmission parameters for the 2nd TB are present in DCI format 0_2 or not.

In some embodiments, when two or more SRS sets are configured and codewords are sent towards two or more different TRPs, two or more transmit power control (TPC) fields may be present in the DCI. Each of the two or more TPC fields may be used to provide a closed-loop power control command associated to a respective codeword or closed-loop index.

In some embodiments, one of the codewords may be disabled dynamically, which can be indicated in the DCI. For example, one of the transport blocks may be disabled if I_{MCS}=26 and if rv_{id}=1 indicated in the DCI for the corresponding transport block.

In some embodiments, if the total number of layers is greater than 4, new antenna port tables may be needed to signal the associated DMRS ports, one for each layer. A single antenna port field in the DCI may be used to indicate the DMRS ports associated with the two codewords.

For example, when 2 codewords are supported, a single antenna port field in the DCI may be used to indicate the DMRS ports associated with the two codewords. If the maximum total rank=8, up to 8 DMRS ports are need to be signaled. For total rank up to 4, the existing antenna port tables defined in 3GPP TS 38.212 v16.6.0 (i.e., Tables 7.3.1.1.2-9 to 7.3.1.1.2-23) may be reused when transform precoder is disabled. For total rank greater than 4, the following tables Table 7 to Table 9 may be used to signal 5 to 8 DMRS ports. However, the present disclosure is not limited thereto.

TABLE 7
Antenna port(s), transform precoder is disabled, dmrs-Type = 1,
maxLength = 2, both codewords are enabled, and total number of
layers is greater than 4

| Antenna port | Number of DMRS CDM | DMRS | Number of |
|---|---|---|---|
| field Value | group(s) without data | port(s) | front-load symbols |
| 0 | 2 | 0-4 | 2 |
| 1 | 2 | 0, 1, 2, 3, 4, 6 | 2 |
| 2 | 2 | 0, 1, 2, 3, 4, 5, 6 | 2 |
| 3 | 2 | 0, 1, 2, 3, 4, 5, 6, 7 | 2 |
| 4-15 | Reserved | Reserved | Reserved |

TABLE 8
Antenna port(s), transform precoder is disabled, dmrs-
Type = 2, maxLength = 1, both codewords
are enabled, and total number of layers is greater than 4

| Antenna port | Number of DMRS CDM | DMRS | Number of |
|---|---|---|---|
| field Value | group(s) without data | port(s) | front-load symbols |
| 0 | 3 | 0-4 | 1 |
| 1 | 3 | 0-5 | 1 |
| 4-15 | Reserved | Reserved | Reserved |

TABLE 9
Antenna port(s), transform precoder is disabled, dmrs-Type = 2, maxLength=2,
both codewords are enabled, and total number of layers is greater than 4.

| Antenna port | Number of DMRS CDM | DMRS | Number of |
|---|---|---|---|
| field Value | group(s) without data | port(s) | front-load symbols |
| 0 | 2 | 0-4 | 2 |
| 1 | 2 | 0, 1, 2, 3, 4, 6 | 2 |
| 2 | 2 | 0, 1, 2, 3, 4, 5, 6 | 2 |
| 3 | 2 | 0, 1, 2, 3, 4, 5, 6, 7 | 2 |
| 4-31 | Reserved | Reserved | Reserved |

If transform precoder is enabled and two codewords, one towards each TRP, are enabled for PUSCH transmission to two TRPs. The existing tables in 3GPP TS 38.212 v16.6.0 (i.e., Table 7.3.1.1.2-6 to Table 7.3.1.1.2-7A) may indicate only one DMRS port while two DMRS ports are need to be indicated, one for each codeword. Thus, new antenna port tables are needed to signal the associated DMRS ports. Table 10 and Table 11 are two new tables that can be used to achieve the purpose, where the 1st DMRS port is for the 1st codeword and the 2nd DMRS port is for the 2nd codeword.

TABLE 10
Antenna port(s), transform precoder is enabled, dmrs-Type =
1, maxLength = 1, both codewords are enabled

| Antenna port | Number of DMRS CDM | DMRS | Number of |
|---|---|---|---|
| field Value | group(s) without data | port(s) | front-load symbols |
| 0 | 2 | 0, 1 | 1 |
| 1 | 2 | 2, 3 | 1 |
| 2 | 2 | 0, 2 | 1 |
| 3 | 2 | 1, 3 | 1 |

TABLE 11
Antenna port(s), transform precoder is enabled, dmrs-Type =
1, maxLength = 2, both codewords are enabled

| Antenna port | Number of DMRS CDM | DMRS | Number of |
|---|---|---|---|
| field Value | group(s) without data | port(s) | front-load symbols |
| 0 | 2 | 0, 1 | 1 |
| 1 | 2 | 2, 3 | 1 |
| 2 | 2 | 0, 2 | 1 |
| 3 | 2 | 1, 3 | 1 |
| 4 | 2 | 0, 1 | 2 |
| 5 | 2 | 2, 3 | 2 |
| 6 | 2 | 0, 2 | 2 |
| 7 | 2 | 1, 3 | 2 |
| 8 | 2 | 4, 5 | 2 |
| 9 | 2 | 6, 7 | 2 |
| 10 | 2 | 4, 6 | 2 |
| 11 | 2 | 5, 7 | 2 |
| 12 | 2 | 0, 6 | 2 |
| 13 | 2 | 1, 7 | 2 |
| 14 | 2 | 2, 4 | 2 |
| 15 | 2 | 3, 5 | 2 |

As discussed above, physical layer priority may be indicated by UL DCI (e.g., DCI format 0_1, 0_2) for the PUSCH. The PUSCH may carry UL-SCH data, and may or may not have UCI multiplexed. The PUSCH may also be indicated to carry UCI only (i.e., no UL-SCH data). In NR Rel-16, UCI and/or PUSCH with low PHY priority is dropped if it overlaps in time with UCI and/or PUSCH of high PHY priority. In Rel-17, certain combinations of high PHY priority UCI/PUSCH and low PHY priority UCI/PUSCH are to be supported, for example:
Multiplexing a low-priority HARQ-ACK in a high-priority PUSCH (conveying UL-SCH only).
Multiplexing a high-priority HARQ-ACK in a low-priority PUSCH (conveying UL-SCH only)
Multiplexing a low-priority HARQ-ACK, a high-priority PUSCH conveying UL-SCH, a high-priority HARQ-ACK and/or CSI.
Multiplexing a high-priority HARQ-ACK, a low-priority PUSCH conveying UL-SCH, a low-priority HARQ-ACK and/or CSI.

In some embodiments, the UL DCI may indicate that no UL-SCH data is to be transmitted on PUSCH, i.e., UCI only may be transmitted and, in this case, UCI can be divided into different parts with different parts transmitted on different codewords. In some embodiments, when multiple UCI types of the same PHY priority are to be transmitted on PUSCH, then among the UCIs to be multiplexed, they are first ranked in terms of UCI type priority, from high to low UCI priority as follows:
HARQ-ACK>SR>CSI with higher priority>CSI with lower priority.

Thus, without the presence of different PHY priority levels (i.e., all UCI(s) to be multiplexed have the same PHY priority), the ranking of the overall priority is the same as the ranking of UCI type priority. Then, the basic principle is, UCI(s) of higher UCI priority may be mapped to TB1 (i.e., TB mapped to codeword 1), while UCI(s) of lower UCI priority may be mapped to TB2 (i.e., TB mapped to codeword 2), where TB1 may be assigned transmission parameters to achieve higher reliability than TB2.

In some embodiments, one bit sequence U may be constructed, in which the various UCI(s) to be multiplexed are concatenated, in the order of higher to lower UCI type priority or in the order of lower to higher UCI type priority. For instance, if HARQ-ACK and CSI are to be transmitted, then the bit sequence may be formulated as U=[HARQ-ACK bits; CSI bits]. The bit sequence U may be segmented into TB1 and TB2, and each TB may separately undergo transmission processing such as channel encoding and/or modulation symbol formulation. The symbol sequence of TB1 may be mapped to codeword1, while the symbol sequence of TB2 may be mapped to codeword2.

TB1 and TB2 may be assigned transmission parameters to achieve different levels of reliability. For example, TB1 targets a lower BLER=1e−3, while TB2 targets a higher BLER=1e−1. The transmission parameters that can be used for this purpose include:
MCS.
   For example, TB1 may be given a lower MCS index (e.g., I_{MCS}=4), while TB2 may be given a higher MCS index (e.g., I_{MCS}=6) in the UL DCI. Alternatively, the TB1 may be mapped to a codeword indicated with lower MCS index and TB2 may be mapped to the other codeword with a higher MCS index.
Number of layers.
   For example, TB1 may be given a greater number of MIMO layers (e.g., 2 layers), while TB2 may be given a less number of MIMO layers (e.g., 1 layer).

In some embodiments, all the UCI bits may be mapped to only one of the codewords having the lowest MCS index indicated in the DCI or mapped to the codeword with largest number of layers.

The reason to multiplex UCI to codeword with greater number of layers is that if UCI is going to take a fixed number of time frequency resources, then a codeword with more resources (i.e., more layers) will be affected less by the UCI that is multiplexed onto the PUSCH.

The reason to multiplex UCI to codeword with lower MCS is that if UCI is going to take a fixed number of time frequency resources, then a codeword with lower MCS will be better to withstand the impact from UCI that is multiplexed onto the PUSCH.

In some embodiments, the same UCI bits may be repeated in all codewords. The UCI bits to be sent in a codeword may be rate matched according to the number of layers and modulation level associated with the codeword.

In some embodiments, when multiple PHY transmission priorities are provided for UL transmission, the PHY priority may be combined with UCI type priority in ranking the UCIs. For example, two PHY priorities may be provided, for example, high PHY priority (HP) associated with priority index=0, and low PHY priority (LP) associated with priority index=1. Then one exemplary UCI ranking, from high to low overall priority, may be:
(HP) HARQ-ACK>(HP) SR>(HP) CSI with higher priority>(HP) CSI with lower priority>(LP) HARQ-ACK>(LP) SR>(LP) CSI with higher priority>(LP) CSI with lower priority.

Another exemplary UCI ranking, from high to low overall priority, may be:
(HP) HARQ-ACK>(HP) SR>(LP) HARQ-ACK>(LP) SR>(HP) CSI with higher priority>(HP) CSI with lower priority>(LP) SR>(LP) CSI with higher priority>(LP) CSI with lower priority.

However, the present disclosure is not limited thereto. Other UCI ranking orders may be possible. For brevity of discussion, they are also included, although not listed explicitly here.

In some embodiments, when multiple codewords are transmitted on PUSCH, priority of each TB may be determined based on one or more of the following ways:
The TB priority is signaled in DCI or CG grant
   In one example, the ‘priority indicator’ field in the UL DCI (e.g., DCI format 0_1, 0_2) may provide PHY priority index of the multiple TBs carried by the PUSCH.
   In another example, a ‘CW priority’ field (i.e., field indicating codeword priority) may be introduced in the UL DCI for each TB. For example, if a TB is indicated with ‘CW priority’ of value 0, then this TB may have a lower codeword priority; otherwise, if a TB is indicated with ‘CW priority’ of value 1, then this TB may have a higher codeword priority, or the other way around.
The TB priority may be implicitly determined by one or more of the following transmission parameters:
   Relative MCS index value. For example, a TB given a higher MCS index may be considered to have lower codeword priority, while a TB given a lower MCS index may be considered to have higher codeword priority, or the other way around.
   Relative number of MIMO layers. For example, a TB given a smaller number of MIMO layers may be considered to have lower codeword priority, while a TB given a larger number of MIMO layers may be considered to have higher codeword priority, or the other way around.
   Relative size of the TBs being carried. For example, a TB of larger size may be considered to have lower codeword priority, while a TB of smaller size may be considered to have higher codeword priority, or the other way around.

In some embodiments, one or more of the following priorities may be considered when determining whether UCI should be multiplexed with PUSCH or which codeword of the PUSCH:
UCI type priority of the UCI(s) to be multiplexed;
PHY priority of the UCI(s) to be multiplexed;
Relative codeword priority of TB1 and TB2; and
PHY priority of the whole PUSCH.

For DG PUSCH, the PHY priority may be provided by the ‘priority indicator’ in the scheduling DCI, with priority indicator=0 indicating a low PHY priority, and priority indicator=1 indicating a high PHY priority. For configured grant, RRC parameter ‘phy-PriorityIndex’ may provide the PHY priority, where value p0 may indicate a low PHY priority and value p1 may indicate a high PHY priority.

In one example, when UCI of different PHY priorities, HP UCI (e.g., HP HARQ-ACK) and LP UCI (e.g., LP HARQ-ACK) are to be multiplexed onto the same PUSCH, then the HP UCI may be multiplexed onto the codeword with high codeword priority, and the LP UCI may be multiplexed onto the codeword with high codeword priority.

In another example, all UCIs may be multiplexed onto a codeword of a given codeword priority. For example, all UCIs may be multiplexed onto the codeword of a lower codeword priority, so that UL-SCH data on the codeword of a higher codeword priority may be protected. In yet another example, all UCIs may be multiplexed onto the codeword of a higher codeword priority, so that the UCI can be transmitted reliably.

In another example, all UCIs to be multiplexed may be ranked in overall priority. Then UCIs of a higher overall priority may be multiplexed onto one codeword (e.g., the CW of a higher CW priority), while UCIs of a lower overall priority may be multiplexed onto the other codeword (e.g., the CW of a lower CW priority). In some embodiments, the overall UCI priority may be a function of both the PHY priority of the UCI and the UCI type priority of the UCI.

In another example, the PHY priority of the whole PUSCH may be used to determine the allowed UCI to multiplex. For example, a PUSCH of a high PHY priority may only allow multiplexing of HP UCI and LP HARQ-ACK (i.e., other LP UCI such as LP SR or LP CSI cannot be multiplexed onto a HP PUSCH). Then, among the allowed UCI(s), those of high PHY priority may be multiplexed onto the codeword of high CW priority, while those of low PHY priority may be multiplexed onto the codeword of low CW priority.

In some embodiments, the UE may be higher layer configured (e.g., via RRC) or predetermined on which UCI types or parts to multiplex onto different codewords. For example, the UE may be configured to multiplex HARQ-ACK and SR on the first codeword; CSI may be configured to be multiplexed on the second codeword.

For a PUSCH configured with multiple codewords transmission, PUSCH repetition can be applied, similar to the case of PUSCH without repetition.

In some embodiments, for a PUSCH configured with multiple codewords transmission, PUSCH repetition type A may be applied, where a PUSCH transmission may be repeated across multiple slots, and each PUSCH repetition may occupy the same time resources of each slot (i.e., each slot uses the same Start and length indicator value (SLIV)). In some embodiments, frequency hopping (FH) may be additionally applied to the PUSCH repetitions, in the manner of inter-repetition FH, intra-slot FH, or inter-slot frequency hopping. Note that PUSCH repetition type A may be restricted to a single PUSCH layer in NR up to Rel-17. Therefore, to enable multiple codeword transmission on PUSCH, this restriction may be removed and the UE may be configured to support more than 1 layer for PUSCH repetition type A (e.g., one layer corresponding to codeword 1 and another layer corresponding to codeword 2). In some embodiments, each PUSCH repetition may carry the same two codewords (i.e., carry the same two transport blocks).

In some embodiments, for a PUSCH configured with multiple codewords transmission, PUSCH repetition type B may be applied. A PUSCH transmission may be repeated across multiple sub-slots or slots, and each PUSCH repetition may occupy different time resources in each slot, and/or two or more PUSCH repetitions may exist in the same slot. In some embodiments, frequency hopping may be additionally applied to the PUSCH repetitions, in the manner of inter-repetition FH, intra-slot FH, or inter-slot frequency hopping. In some embodiments, each PUSCH repetition may carry the same two codewords (i.e., carry the same two transport blocks).

In some embodiments, one subset of the PUSCH repetitions may carry the entire set of multiple codewords (e.g., two codewords), while another subset of the PUSCH repetitions may carry a reduced set from multiple codewords (e.g., carry the first codeword only).

For instance, a PUSCH may be provided with 8 repetitions. In N repetitions, two codewords (e.g., TB1 and TB2) may be carried. In the remaining (8-N) repetitions, only one codeword (e.g., TB1) may be carried. The (8-N) repetitions may carry the reduced set of codewords due to insufficient resources for the full set of codewords, e.g., the number of OFDM symbols available for each of the (8-N) repetitions may be less than a threshold (e.g., <=2 OFDM symbols). Typically, the codeword that is transmitted in more repetitions (e.g., TB1) may be received with higher reliability than the codeword that is transmitted in fewer repetitions (e.g., TB2). Hence this can be taken into account to assign higher-priority TB to TB1, while assign the lower priority TB to TB2.

The above embodiment may be applicable to PUSCH repetition Type A and Type B or any other types of PUSCH repetition e.g. the enhanced Type A PUSCH repetitions in NR Rel-17.

With the above embodiments, uplink transmission with multiple codewords may be achieved between a UE and one or more gNBs/TRPs, such that a higher throughput, a higher reliability, and a faster response for the uplink transmission may be achieved.

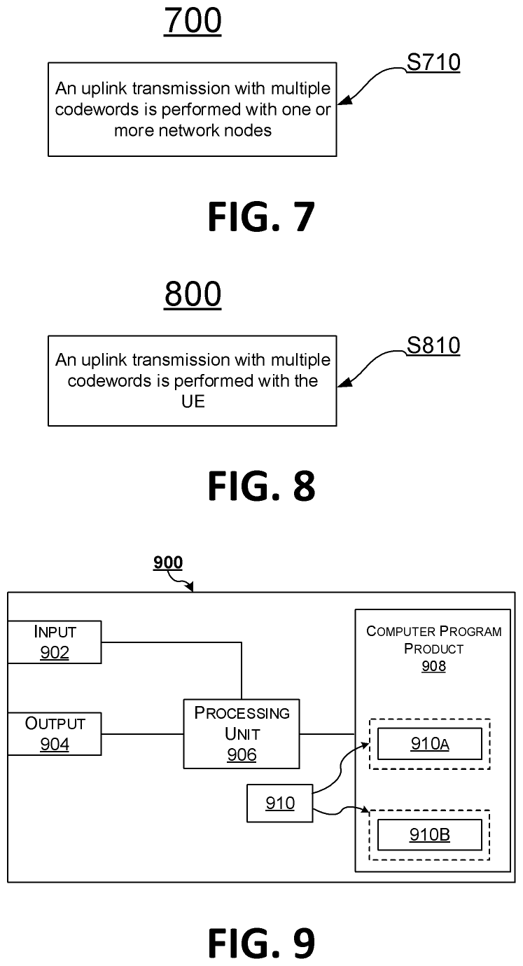

FIG. 7 is a flow chart of an exemplary method 700 at a UE for uplink transmission with multiple codewords according to an embodiment of the present disclosure. The method 700 may be performed at a user equipment (e.g., the UE 110). The method 700 may comprise step S710. However, the present disclosure is not limited thereto. In some other embodiments, the method 700 may comprise more steps, different steps, or any combination thereof. Further the steps of the method 700 may be performed in a different order than that described herein when multiple steps are involved. Further, in some embodiments, a step in the method 700 may be split into multiple sub-steps and performed by different entities, and/or multiple steps in the method 700 may be combined into a single step.

The method 700 may begin at step S710 where an uplink transmission with multiple codewords may be performed with one or more network nodes.

In some embodiments, before the step S710, the method 700 may further comprise: transmitting, to at least one of the one or more network nodes, a message indicating whether uplink transmission with multiple codewords is supported by the UE or not. In some embodiments, the message may indicate at least one of: —whether CG based uplink transmission with multiple codewords is supported by the UE or not; —whether Type 1 CG based uplink transmission with multiple codewords is supported by the UE or not; —whether Type 2 CG based uplink transmission with multiple codewords is supported by the UE or not; and —whether DG based uplink transmission with multiple codewords is supported by the UE or not. In some embodiments, the message may only indicate whether DG based uplink transmission with multiple codewords is supported by the UE or not. In some embodiments, after the step of transmitting the message, the method 700 may further comprise: receiving, from the at least one network node, a configuration indicating whether a single codeword or multiple codewords shall be used by the UE for its uplink transmission. In some embodiments, the configuration may be received via UE-specific RRC signaling.

In some embodiments, when the uplink transmission is Type 2 CG-based uplink transmission or DG based uplink transmission and before the step S710, the method 700 may further comprise: receiving, from at least one of the network nodes, a DCI message for scheduling the uplink transmission. In some embodiments, for at least one of the multiple codewords, the DCI message may comprise at least one field for at least one of: —an MCS; —an NDI; and —an RV. In some embodiments, the DCI message may be a DCI message of a legacy DCI format. In some embodiments, the DCI message may be a DCI format 0_0, 0_1 or 0_2 message. In some embodiments, the DCI message may be not a DCI message of a legacy DCI format. In some embodiments, the step of receiving, from at least one of the network nodes, a DCI message for scheduling the uplink transmission may comprise: receiving, from at least one of the network nodes, multiple DCI messages for jointly scheduling the uplink transmission. In some embodiments, the multiple DCI messages may comprise at least a first DCI message scheduling one or more parameters for a first of the multiple codewords and a second DCI message scheduling one or more parameters for a second of the multiple codewords.

In some embodiments, when the uplink transmission is Type 1 CG-based uplink transmission and before the step S710, the method 700 may further comprise: receiving, from at least one of the network nodes, an RRC message scheduling the uplink transmission. In some embodiments, for at least one of the multiple codewords, the RRC message may comprise at least one field for at least one of: —an MCS index; —an MCS table; —information for precoding and number of layers; and —an SRI. In some embodiments, the RRC message may comprise a ConfiguredGrantConfig IE that comprises at least one of: —a precodingAndNumberOfLayers2ndTB IE for configuring the information for precoding and number of layers for a codeword; —a srs-ResourceIndicator2ndTB IE for configuring the SRI for the codeword; and —a mcsAndTBS2ndTB IE for configuring modulation order, target code rate, and/or TB size for the codeword.

In some embodiments, before the step of performing the uplink transmission, the method 700 may further comprise: receiving, from at least one of the network nodes, an RRC message indicating a maximum number of codewords for uplink transmission. In some embodiments, the RRC message may comprise at least one of: —a maxNrofCodeWordsScheduledByDCI-0-1 IE in a PUSCH-Config IE indicating a maximum number of codewords for DG based uplink transmission scheduled by a DCI format 0_1 message; —a maxNrofCodeWordsScheduledByDCI-0-2 IE in a PUSCH-Config IE indicating a maximum number of codewords for DG based uplink transmission scheduled by a DCI format 0_2 message; —a maxNrofCodeWords IE in a PUSCH-Config IE indicating a maximum number of codewords for any uplink transmission to the at least one network node; —a maxNrofCodeWordsScheduledByDCI-0-1 IE in a PUSCH-Config IE indicating a maximum number of codewords for DG based uplink transmission and/or Type 2 CG based uplink transmission scheduled by a DCI format 0_1 message; —a maxNrofCodeWordsScheduledByDCI-0-2 IE in a PUSCH-Config IE indicating a maximum number of codewords for DG based uplink transmission and/or Type 2 CG based uplink transmission scheduled by a DCI format 0_2 message; —a maxNrofCodeWordsScheduledByRRC IE in a PUSCH-Config IE indicating a maximum number of codewords for Type 1 CG based uplink transmission schedule by RRC signaling; and —a maxNrofCodeWords IE in a ConfiguredGrantConfig IE indicating a maximum number of codewords for CG based uplink transmission.

In some embodiments, the uplink transmission may be targeted towards two or more of the network nodes. In some embodiments, the uplink transmission may comprise at least one or more first transmission layers targeted towards a first of the two or more network nodes and one or more second transmission layers targeted towards a second of the two or more network nodes. In some embodiments, all the transmission layers may be transmitted over a same time-frequency resource. In some embodiments, for each of the two or more network nodes, the uplink transmission may comprise a same or different number of transmission layers targeted towards the corresponding network node. In some embodiments, the uplink transmission may be DG based uplink transmission or Type 2 CG based uplink transmission. In some embodiments, one or more DCI messages that are received by the UE and schedule the uplink transmission may comprise, for each of the multiple codewords, at least one of: —MCS; —RV; —TPMI and/or a number of transmission layers when the uplink transmission is a codebook based uplink transmission; and —one or more SRIs. In some embodiments, when the uplink transmission is codebook based uplink transmission, the one or more DCI messages may comprise, for each of the multiple codewords, a single or no SRI, wherein when the uplink transmission is non-codebook based uplink transmission, the one or more DCI messages comprise, for each of the multiple codewords, one or more SRIs. In some embodiments, a first SRI configured for a first codeword may indicate an SRS resource from a first SRS resource set, wherein a second SRI configured for a second codeword may indicate an SRS resource from a second SRS resource set that is different from the first SRS resource set.

In some embodiments, the method 700 may further comprise: receiving, from a network node, a message indicating that at least one of the multiple codewords is disabled; and performing, with the network node, another uplink transmission with the at least one codeword disabled. In some embodiments, the message may be a DCI message comprising multiple fields, and a combination of specific values of the one or more of the multiple fields indicates that a corresponding codeword is disabled.

In some embodiments, the method 700 may further comprise: receiving, from at least one of the network nodes, a message indicating a configuration for DMRS ports for the multiple codewords. In some embodiments, the message may be a DCI message comprising a single antenna port field that indicates the configuration for DMRS ports for the multiple codewords. In some embodiments, the single antenna port field may be decoded as follows: —referring to one or more first antenna port tables when the transform precoder is disabled and when a number of transmission layers is less than or equal to 4; —referring to one or more second antenna port tables that are different from the one or more first antenna port tables when the transform precoder is disabled and when the number of transmission layers is greater than 4; and —referring to one or more third antenna port tables when the transform precoder is enabled.

In some embodiments, before the step S710, the method 700 may further comprise: receiving, from at least one of the network nodes, a DCI message for scheduling the uplink transmission and indicating that no Uplink Shared Channel (UL-SCH) data is to be transmitted in the uplink transmission, wherein the step S710 may comprise: performing the uplink transmission comprising multiple UCI that are mapped to one or more codewords.

In some embodiments, each of the multiple UCI may have one of multiple UCI type priorities, wherein a first UCI having a first UCI type priority is mapped to a first codeword while a second UCI having a second UCI type priority that is lower than the first UCI type priority is mapped to a second codeword that is different from the first codeword. In some embodiments, UCI type priorities may be ordered from high to low as follows: HARQ-ACK, SR, CSI with a higher CSI priority, and CSI with a lower CSI priority. In some embodiments, the step of performing the uplink transmission comprising multiple UCI that are mapped to different codewords, respectively, may comprise: constructing a bit sequence by concatenating the multiple UCI in a decreasing or increasing order of their type priorities; and segmenting the bit sequence into multiple segments such that the multiple segments are mapped to the multiple codewords in an one-to-one manner. In some embodiments, one or more transmission parameters that are configured for a TB associated with the first codeword may have values for achieving a higher reliability than that achieved by one or more corresponding transmission parameters that are configured for a TB associated with the second codeword. In some embodiments, the one or more transmission parameters may comprise at least one of: —MCS; and —the number of transmission layers.

In some embodiments, the multiple UCI may be mapped to one of the multiple codewords that has the lowest MCS index and/or the greatest number of transmission layers. In some embodiments, the bits of the multiple UCIs may be repeated for all codewords. In some embodiments, a part of the bits of the multiple UCIs that is mapped to a codeword may be rate matched according to the number of transmission layers and/or MCS level associated with the corresponding codeword. In some embodiments, each of the multiple UCI may have one of multiple UCI type priorities and one of multiple PHY transmission priorities, wherein a first UCI having a first combination of UCI type priority and PHY transmission priority may be mapped to a first codeword while a second UCI having a second combination of UCI type priority and PHY transmission priority that is different from the first combination may be mapped to a second codeword that is different from the first codeword. In some embodiments, combinations of UCI type priority and PHY transmission priority may be ordered from high to low as follows: —HARQ-ACK with a high PHY transmission priority; —SR with a high PHY transmission priority; —CSI with a higher CSI priority and a high PHY transmission priority; —CSI with a lower CSI priority and a high PHY transmission priority; —HARQ-ACK with a low PHY transmission priority; —SR with a low PHY transmission priority; —CSI with a higher CSI priority and a low PHY transmission priority; and —CSI with a lower CSI priority and a low PHY transmission priority. In some embodiments, combinations of UCI type priority and PHY transmission priority may be ordered from high to low as follows: —HARQ-ACK with a high PHY transmission priority; —SR with a high PHY transmission priority; —HARQ-ACK with a low PHY transmission priority; —SR with a low PHY transmission priority; —CSI with a higher CSI priority and a high PHY transmission priority; —CSI with a lower CSI priority and a high PHY transmission priority; —CSI with a higher CSI priority and a low PHY transmission priority; and —CSI with a lower CSI priority and a low PHY transmission priority.

In some embodiments, before the step S710, the method 700 may further comprise: receiving, from at least one of the network nodes, a message for scheduling the uplink transmission and indicating that UL-SCH data is to be transmitted in the uplink transmission; and determining priorities for multiple TBs associated with the multiple codewords at least partially based on the received message. In some embodiments, the priorities for multiple TBs may be determined based on at least one of: —a priority indicator field in the received message; —a codeword (CW) priority field in the received message; —a relative MCS index value; —a relative number of transmission layers; and —a relative size of TB. In some embodiments, the priorities for multiple TBs may be determined based on at least one of: —a UCI type priority of a UCI to be multiplexed with the uplink transmission; —a PHY transmission priority of a UCI to be multiplexed with the uplink transmission; —relative codeword priorities for the multiple codewords; and —a PHY transmission priority of the uplink transmission. In some embodiments, the PHY transmission priority of the uplink transmission may be determined by a priority indicator field in the received message when the received message is a DCI message, wherein the PHY transmission priority of the uplink transmission may be determined by a “phy-PriorityIndex” field in the received message when the received message is an RRC message.

In some embodiments, a first UCI with a high PHY transmission priority may be multiplexed with a codeword having a high codeword priority, and a second UCI with a low PHY transmission priority may be multiplexed with another codeword having a low codeword priority. In some embodiments, all UCIs may be multiplexed with a codeword having a pre-determined or configured codeword priority. In some embodiments, a first UCI with a high overall priority may be multiplexed with a first codeword, and a second UCI with a low overall priority may be multiplexed with a second codeword that has a lower codeword priority than the first codeword, wherein an overall priority for a UCI may be determined based on at least one of: —PHY transmission priority for the UCI; and —UCI type priority for the UCI. In some embodiments, no UCI that has an overall priority lower than the PHY transmission priority of the uplink transmission may be allowed to be multiplexed with the uplink transmission. In some embodiments, a first UCI with a first PHY transmission priority may be multiplexed with a first codeword having a high codeword priority, and a second UCI with a second PHY transmission priority lower than the first PHY transmission priority may be multiplexed with a second codeword having a low codeword priority.

In some embodiments, before the step S710, the method 700 may further comprise: receiving, from at least one of the network nodes, a message indicating which type or part of UCI is to be multiplexed with which codeword. In some embodiments, which type or part of UCI is to be multiplexed with which codeword may be predetermined. In some embodiments, HARQ-ACK and SR may be multiplexed with a first codeword, and CSI may be multiplexed with a second codeword. In some embodiments, the uplink transmission may be performed with a repetition type A or a repetition Type B. In some embodiments, the uplink transmission may be performed with one of: —inter-repetition frequency hopping (FH); —intra-slot FH; and —inter-slot FH. In some embodiments, each repetition of the uplink transmission may carry the multiple codewords. In some embodiments, a first repetition of the uplink transmission may carry a full set of the multiple codewords, and a second repetition of the uplink transmission may carry a proper subset of the multiple codewords. In some embodiments, the uplink transmission may be PUSCH transmission. In some embodiments, the network node may be a TRP.

FIG. 8 is a flow chart of an exemplary method 800 at a network node for uplink transmission with multiple codewords according to an embodiment of the present disclosure. The method 800 may be performed at a network node (e.g., the gNB 120). The method 800 may comprise step S810. However, the present disclosure is not limited thereto. In some other embodiments, the method 800 may comprise more steps, different steps, or any combination thereof. Further the steps of the method 800 may be performed in a different order than that described herein when multiple steps are involved. Further, in some embodiments, a step in the method 800 may be split into multiple sub-steps and performed by different entities, and/or multiple steps in the method 800 may be combined into a single step.

The method 800 may begin at step S810 where an uplink transmission with multiple codewords may be performed with the UE.

In some embodiments, before the step S810, the method 800 may further comprise: receiving, from the UE, a message indicating whether uplink transmission with multiple codewords is supported by the UE or not. In some embodiments, the message may indicate at least one of: —whether CG based uplink transmission with multiple codewords is supported by the UE or not; —whether Type 1 CG based uplink transmission with multiple codewords is supported by the UE or not; —whether Type 2 CG based uplink transmission with multiple codewords is supported by the UE or not; and —whether DG based uplink transmission with multiple codewords is supported by the UE or not. In some embodiments, the message may only indicate whether DG based uplink transmission with multiple codewords is supported by the UE or not. In some embodiments, after the step of receiving the message, the method 800 may further comprise: transmitting, to the UE, a configuration indicating whether a single codeword or multiple codewords shall be used by the UE for its uplink transmission. In some embodiments, the configuration may be transmitted via UE-specific RRC signaling.

In some embodiments, when the uplink transmission is Type 2 CG-based uplink transmission or DG based uplink transmission and before the step S810, the method 800 may further comprise: transmitting, to the UE, a DCI message for scheduling the uplink transmission. In some embodiments, for at least one of the multiple codewords, the DCI message may comprise at least one field for at least one of: —an MCS; —an NDI; and —an RV. In some embodiments, the DCI message may be a DCI message of a legacy DCI format. In some embodiments, the DCI message may be a DCI format 0_0, 0_1 or 0_2 message. In some embodiments, the DCI message may be not a DCI message of a legacy DCI format. In some embodiments, the step of transmitting, to the UE, a DCI message for scheduling the uplink transmission may comprise: transmitting, to the UE, the DCI message for scheduling at least a part of the uplink transmission. In some embodiments, the multiple DCI messages may comprise at least a first DCI message scheduling one or more parameters for a first of the multiple codewords and a second DCI message scheduling one or more parameters for a second of the multiple codewords. In some embodiments, when the uplink transmission is Type 1 CG-based uplink transmission and before the step S810, the method 800 may further comprise: transmitting, to the UE, an RRC message scheduling the uplink transmission. In some embodiments, for at least one of the multiple codewords, the RRC message may comprise at least one field for at least one of: —an MCS index; —an MCS table; —information for precoding and number of layers; and —an SRI. In some embodiments, the RRC message may comprise a ConfiguredGrantConfig IE that comprises at least one of: —a precodingAndNumberOfLayers2ndTB IE for configuring the information for precoding and number of layers for a codeword; —a srs-ResourceIndicator2ndTB IE for configuring the SRI for the codeword; and —a mcsAndTBS2ndTB IE for configuring modulation order, target code rate, and/or TB size for the codeword.

In some embodiments, before the step S810, the method 800 may further comprise: transmitting, to the UE, an RRC message indicating a maximum number of codewords for uplink transmission. In some embodiments, the RRC message may comprise at least one of: —a maxNrofCodeWordsScheduledByDCI-0-1 IE in a PUSCH-Config IE indicating a maximum number of codewords for DG based uplink transmission scheduled by a DCI format 0_1 message; —a maxNrofCodeWordsScheduledByDCI-0-2 IE in a PUSCH-Config IE indicating a maximum number of codewords for DG based uplink transmission scheduled by a DCI format 0_2 message; —a maxNrofCodeWords IE in a PUSCH-Config IE indicating a maximum number of codewords for any uplink transmission to the at least one network node; —a maxNrofCodeWordsScheduledByDCI-0-1 IE in a PUSCH-Config IE indicating a maximum number of codewords for DG based uplink transmission and/or Type 2 CG based uplink transmission scheduled by a DCI format 0_1 message; —a maxNrofCodeWordsScheduledByDCI-0-2 IE in a PUSCH-Config IE indicating a maximum number of codewords for DG based uplink transmission and/or Type 2 CG based uplink transmission scheduled by a DCI format 0_2 message; —a maxNrofCodeWordsScheduledByRRC IE in a PUSCH-Config IE indicating a maximum number of codewords for Type 1 CG based uplink transmission schedule by RRC signaling; and —a maxNrofCodeWords IE in a ConfiguredGrantConfig IE indicating a maximum number of codewords for CG based uplink transmission.

In some embodiments, the uplink transmission may be targeted towards multiple network nodes comprising the network node. In some embodiments, the uplink transmission may comprise at least one or more first transmission layers targeted towards the network node and one or more second transmission layers targeted towards one or more other network nodes. In some embodiments, all the transmission layers may be transmitted over a same time-frequency resource. In some embodiments, for each of the multiple network nodes, the uplink transmission may comprise a same or different number of transmission layers targeted towards the corresponding network node. In some embodiments, the uplink transmission may be DG based uplink transmission or Type 2 CG based uplink transmission. In some embodiments, one or more DCI messages that are transmitted by the network node and schedule the uplink transmission may comprise, for each of the multiple codewords, at least one of: —MCS; —RV; —TPMI and/or a number of transmission layers when the uplink transmission is a codebook based uplink transmission; and —one or more SRIs. In some embodiments, when the uplink transmission is codebook based uplink transmission, the one or more DCI messages may comprise, for each of the multiple codewords, a single or no SRI, wherein when the uplink transmission is non-codebook based uplink transmission, the one or more DCI messages may comprise, for each of the multiple codewords, one or more SRIs. In some embodiments, a first SRI configured for a first codeword may indicate an SRS resource from a first SRS resource set, wherein a second SRI configured for a second codeword may indicate an SRS resource from a second SRS resource set that is different from the first SRS resource set.

In some embodiments, the method 800 may further comprise: transmitting, to the UE, a message indicating that at least one of the multiple codewords is disabled; and performing, with the UE, another uplink transmission with the at least one codeword disabled. In some embodiments, the message may be a DCI message comprising multiple fields, and a combination of specific values of the one or more of the multiple fields may indicate that a corresponding codeword is disabled. In some embodiments, the method 800 may further comprise: transmitting, to the UE, a message indicating a configuration for DMRS ports for the multiple codewords. In some embodiments, the message may be a DCI message comprising a single antenna port field that indicates the configuration for DMRS ports for the multiple codewords. In some embodiments, the single antenna port field may be encoded as follows: —referring to one or more first antenna port tables when the transform precoder is disabled and when a number of transmission layers is less than or equal to 4; —referring to one or more second antenna port tables that are different from the one or more first antenna port tables when the transform precoder is disabled and when the number of transmission layers is greater than 4; and —referring to one or more third antenna port tables when the transform precoder is enabled.

In some embodiments, before the step S810, the method 800 may further comprise: transmitting, to the UE, a DCI message for scheduling the uplink transmission and indicating that no UL-SCH data is to be transmitted in the uplink transmission, wherein the step of performing the uplink transmission may comprise: performing the uplink transmission comprising multiple UCI that are mapped to one or more codewords.

In some embodiments, each of the multiple UCI may have one of multiple UCI type priorities, wherein a first UCI having a first UCI type priority may be mapped to a first codeword while a second UCI having a second UCI type priority that is lower than the first UCI type priority may be mapped to a second codeword that is different from the first codeword. In some embodiments, UCI type priorities may be ordered from high to low as follows: HARQ-ACK, SR, CSI with a higher CSI priority, and CSI with a lower CSI priority. In some embodiments, the step of performing the uplink transmission comprising multiple UCI that are mapped to different codewords, respectively, may comprise: receiving, from the UE, the uplink transmission; decoding the uplink transmission to determine multiple segments that are mapped to the multiple codewords of the uplink transmission in an one-to-one manner; and determining the multiple UCI that are ordered in a decreasing or increasing order of their type priorities from the multiple segments.

In some embodiments, one or more transmission parameters that are configured for a TB associated with the first codeword may have values for achieving a higher reliability than that achieved by one or more corresponding transmission parameters that are configured for a TB associated with the second codeword. In some embodiments, the one or more transmission parameters may comprise at least one of: —MCS; and —the number of transmission layers. In some embodiments, the multiple UCI may be mapped to one of the multiple codewords that has the lowest MCS index and/or the greatest number of transmission layers. In some embodiments, the bits of the multiple UCIs may be repeated for all codewords.

In some embodiments, a part of the bits of the multiple UCIs that is mapped to a codeword may be rate matched according to the number of transmission layers and/or MCS level associated with the corresponding codeword. In some embodiments, each of the multiple UCI may have one of multiple UCI type priorities and one of multiple PHY transmission priorities, wherein a first UCI having a first combination of UCI type priority and PHY transmission priority may be mapped to a first codeword while a second UCI having a second combination of UCI type priority and PHY transmission priority that is different from the first combination may be mapped to a second codeword that is different from the first codeword. In some embodiments, combinations of UCI type priority and PHY transmission priority may be ordered from high to low as follows: —HARQ-ACK with a high PHY transmission priority; —SR with a high PHY transmission priority; —CSI with a higher CSI priority and a high PHY transmission priority; —CSI with a lower CSI priority and a high PHY transmission priority; —HARQ-ACK with a low PHY transmission priority; —SR with a low PHY transmission priority; —CSI with a higher CSI priority and a low PHY transmission priority; and —CSI with a lower CSI priority and a low PHY transmission priority. In some embodiments, combinations of UCI type priority and PHY transmission priority may be ordered from high to low as follows: —HARQ-ACK with a high PHY transmission priority; —SR with a high PHY transmission priority; —HARQ-ACK with a low PHY transmission priority; —SR with a low PHY transmission priority; —CSI with a higher CSI priority and a high PHY transmission priority; —CSI with a lower CSI priority and a high PHY transmission priority; —CSI with a higher CSI priority and a low PHY transmission priority; and —CSI with a lower CSI priority and a low PHY transmission priority.

In some embodiments, before the step S810, the method 800 may further comprise: determining priorities for multiple TBs associated with the multiple codewords; and transmitting, to the UE, a message for scheduling the uplink transmission and indicating that UL-SCH data is to be transmitted in the uplink transmission at least partially based on the determined priorities for the multiple TBs. In some embodiments, the priorities for the multiple TBs may be determined based on at least one of: —a priority indicator field in the received message; —a CW priority field in the received message; —a relative MCS index value; —a relative number of transmission layers; and —a relative size of TB. In some embodiments, the priorities for multiple TBs may be determined based on at least one of: —a UCI type priority of a UCI to be multiplexed with the uplink transmission; —a PHY transmission priority of a UCI to be multiplexed with the uplink transmission; —relative codeword priorities for the multiple codewords; and —a PHY transmission priority of the uplink transmission.

In some embodiments, the PHY transmission priority of the uplink transmission may be determined by a priority indicator field in the received message when the received message is a DCI message, wherein the PHY transmission priority of the uplink transmission may be determined by a “phy-PriorityIndex” field in the received message when the received message is an RRC message. In some embodiments, a first UCI with a high PHY transmission priority may be multiplexed with a codeword having a high codeword priority, and a second UCI with a low PHY transmission priority may be multiplexed with another codeword having a low codeword priority. In some embodiments, all UCIs may be multiplexed with a codeword having a pre-determined or configured codeword priority. In some embodiments, a first UCI with a high overall priority may be multiplexed with a first codeword, and a second UCI with a low overall priority may be multiplexed with a second codeword that has a lower codeword priority than the first codeword, wherein an overall priority for a UCI may be determined based on at least one of: —PHY transmission priority for the UCI; and —UCI type priority for the UCI. In some embodiments, no UCI that has an overall priority lower than the PHY transmission priority of the uplink transmission may be allowed to be multiplexed with the uplink transmission. In some embodiments, a first UCI with a first PHY transmission priority may be multiplexed with a first codeword having a high codeword priority, and a second UCI with a second PHY transmission priority lower than the first PHY transmission priority may be multiplexed with a second codeword having a low codeword priority.

In some embodiments, before the step S810, the method 800 may further comprise: transmitting, to the UE, a message indicating which type or part of UCI is to be multiplexed with which codeword. In some embodiments, which type or part of UCI is to be multiplexed with which codeword may be predetermined. In some embodiments, HARQ-ACK and SR may be multiplexed with a first codeword, and CSI may be multiplexed with a second codeword. In some embodiments, the uplink transmission may be performed with a repetition type A or a repetition Type B. In some embodiments, the uplink transmission may be performed with one of: —inter-repetition FH; —intra-slot FH; and —inter-slot FH. In some embodiments, each repetition of the uplink transmission may carry the multiple codewords. In some embodiments, a first repetition of the uplink transmission may carry a full set of the multiple codewords, and a second repetition of the uplink transmission may carry a proper subset of the multiple codewords. In some embodiments, the uplink transmission may be PUSCH transmission. In some embodiments, the network node may be a TRP.

FIG. 9 schematically shows an embodiment of an arrangement 900 which may be used in a user equipment (e.g., the UE 110) or a network node (e.g., the gNB 120) according to an embodiment of the present disclosure. Comprised in the arrangement 900 are a processing unit 906, e.g., with a Digital Signal Processor (DSP) or a Central Processing Unit (CPU). The processing unit 906 may be a single unit or a plurality of units to perform different actions of procedures described herein. The arrangement 900 may also comprise an input unit 902 for receiving signals from other entities, and an output unit 904 for providing signal(s) to other entities. The input unit 902 and the output unit 904 may be arranged as an integrated entity or as separate entities.

Furthermore, the arrangement 900 may comprise at least one computer program product 908 in the form of a non-volatile or volatile memory, e.g., an Electrically Erasable Programmable Read-Only Memory (EEPROM), a flash memory and/or a hard drive. The computer program product 908 comprises a computer program 910, which comprises code/computer readable instructions, which when executed by the processing unit 906 in the arrangement 900 causes the arrangement 900 and/or the UE/network node in which it is comprised to perform the actions, e.g., of the procedure described earlier in conjunction with FIG. 6 to FIG. 8 or any other variant.

The computer program 910 may be configured as a computer program code structured in computer program modules 910A. Hence, in an exemplifying embodiment when the arrangement 900 is used in a UE, the code in the computer program of the arrangement 900 includes: a module 910A for performing, with one or more network nodes, an uplink transmission with multiple codewords.

Further, the computer program 910 may be further configured as a computer program code structured in computer program modules 910B. Hence, in an exemplifying embodiment when the arrangement 900 is used in a network node, the code in the computer program of the arrangement 900 includes: a module 910B for performing, with the UE, an uplink transmission with multiple codewords.

The computer program modules could essentially perform the actions of the flow illustrated in FIG. 6 to FIG. 8, to emulate the UE or the network node. In other words, when the different computer program modules are executed in the processing unit 906, they may correspond to different modules in the UE or the network node.

Although the code means in the embodiments disclosed above in conjunction with FIG. 9 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

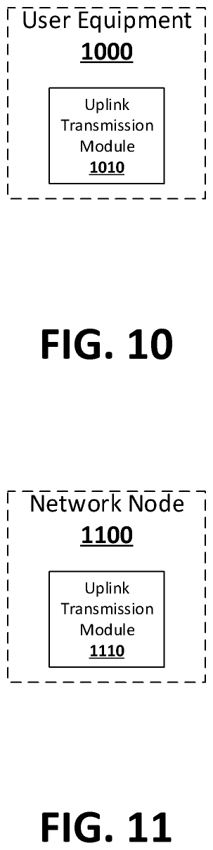

Correspondingly to the method 700 as described above, an exemplary user equipment is provided. FIG. 10 is a block diagram of a UE 1000 according to an embodiment of the present disclosure. The UE 1000 may be, e.g., the UE 110 in some embodiments.

The UE 1000 may be configured to perform the method 700 as described above in connection with FIG. 7. As shown in FIG. 10, the UE 1000 may comprise an uplink transmission module 1010 for performing, with one or more network nodes, an uplink transmission with multiple codewords.

The above module 1010 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7. Further, the UE 1000 may comprise one or more further modules, each of which may perform any of the steps of the method 700 described with reference to FIG. 7.

Correspondingly to the method 800 as described above, a network node is provided. FIG. 11 is a block diagram of an exemplary network node 1100 according to an embodiment of the present disclosure. The network node 1100 may be, e.g., the gNB 120 in some embodiments.

The network node 1100 may be configured to perform the method 800 as described above in connection with FIG. 8. As shown in FIG. 11, the network node 1100 may comprise an uplink transmission module 1110 for performing, with the UE, an uplink transmission with multiple codewords.

The above module 1110 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the network node 1100 may comprise one or more further modules, each of which may perform any of the steps of the method 800 described with reference to FIG. 8.

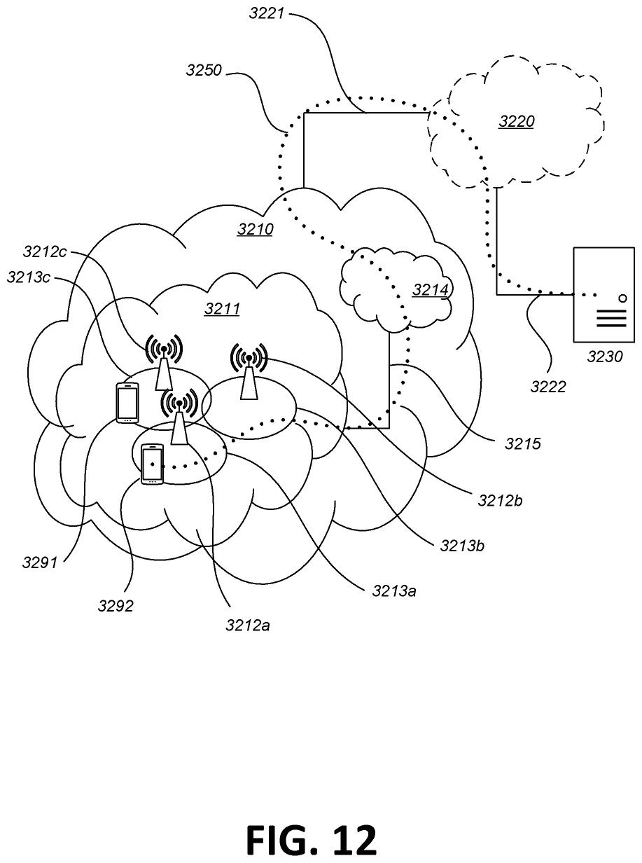

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

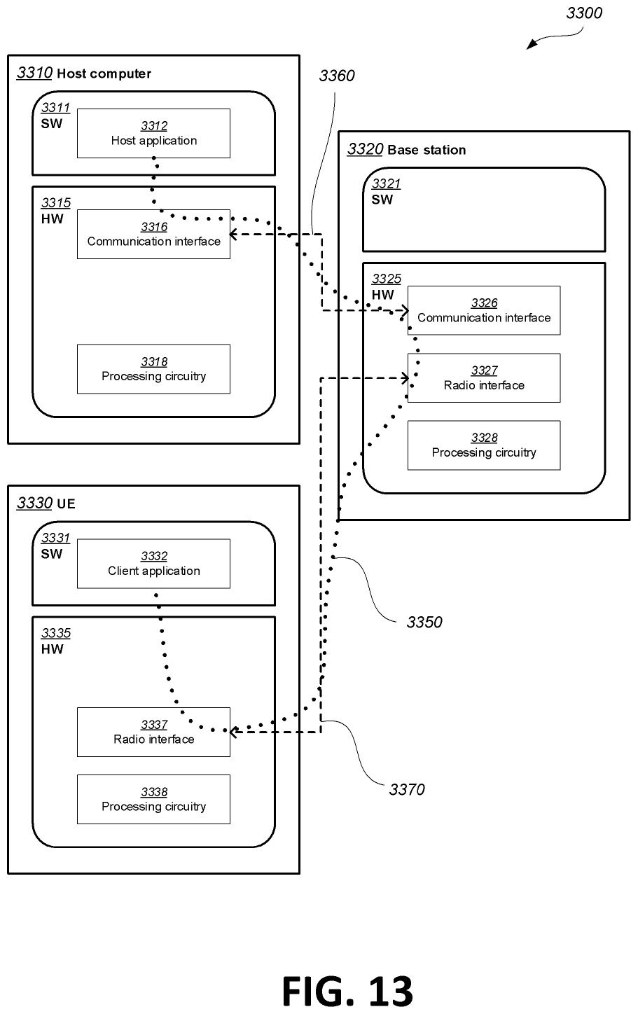

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

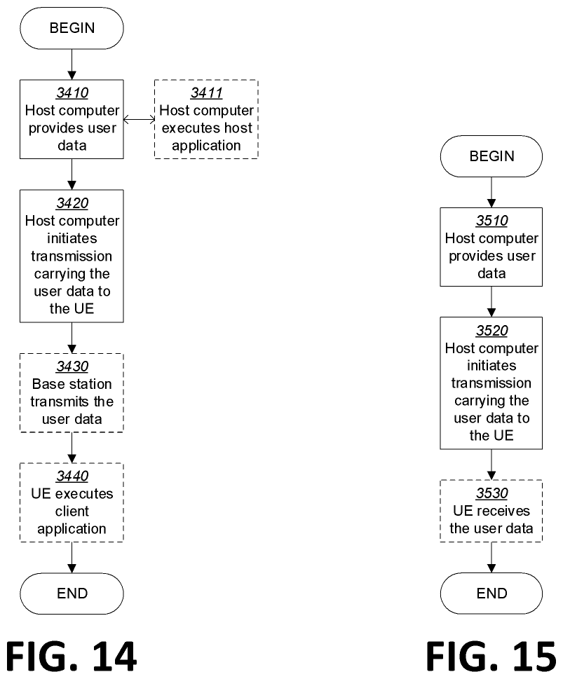

FIG. 14 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

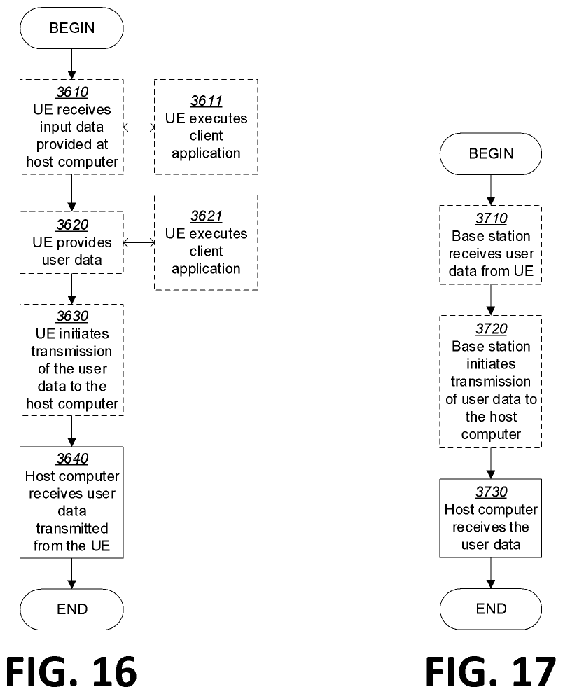

FIG. 16 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 16 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

### Abbreviation Explanation

BS Base station
CB Code Block
CBG Code Block Group
CBGTI Code Block Group Transmission Information
CG Configured Grant
CRC Cyclic Redundancy Check
CRM Contention Resolution Message
CSI Channel State Information
DCI Downlink Control Information
DG Dynamic Grant
DL Downlink
DM-RS Demodulation Reference Signal
eMTC Enhanced Machine Type Communication
FH Frequency Hopping
FR1 Frequency Range 1
FR2 Frequency Range 2
gNB Network Node in NR
HARQ Hybrid Automated Retransmission Request
MAC Medium Access Control
Msg3 Message 3
NB-IoT Narrow-Band Internet of Things
NR New Radio
PDCCH Physical Downlink Control Channel
PUSCH Physical Uplink Shared Data Channel
PRB Physical Resource Block, i.e., 12 consecutive subcarriers
RE Resource Element
RNTI Radio Network Temporary Identifier
RSRP Reference Signal Received Power
RV Redundancy Version
SPS Semi-Persistent Scheduling
TB Transport Block
TBS TB Size
TxD Transmit Diversity
UE User Equipment
UL Uplink

1. A method at a user equipment (UE) for uplink transmission with multiple codewords, the method comprising:
performing, with one or more network nodes, an uplink transmission with multiple codewords.

2-6. (canceled)

7. The method of claim 1, wherein when the uplink transmission is Type 2 CG-based uplink transmission or DG based uplink transmission and before the step of performing the uplink transmission, the method further comprises:
receiving, from at least one of the network nodes, at least one Downlink Control Information (DCI) message for scheduling the uplink transmission.

8. The method of claim 7, wherein for at least one of the multiple codewords, the DCI message comprises at least one field for at least one of:
a Modulation and Coding Scheme (MCS);
a New Data Indicator (NDI); and
a Redundancy Version (RV).

9. (canceled)

10. The method of claim 7, wherein the DCI message is a DCI format 0_0, 0_1 or 0_2 message.

11-26. (canceled)

27. The method of claim 1, further comprising:
receiving, from a network node, a message indicating that at least one of the multiple codewords is disabled.

28. The method of claim 27, wherein the message is a DCI message comprising multiple fields, and a combination of specific values of the one or more of the multiple fields indicates that a corresponding codeword is disabled.

29. The method of claim 1, further comprising:
receiving, from at least one of the network nodes, a message indicating a configuration for Demodulation Reference Signal (DMRS) ports for the multiple codewords.

30. The method of claim 29, wherein the message is a DCI message comprising a single antenna port field that indicates the configuration for DMRS ports for the multiple codewords.

31. The method of claim 30, wherein the single antenna port field is decoded by at least one of:
referring to one or more first antenna port tables when the transform precoder is disabled and when a number of transmission layers is less than or equal to 4;
referring to one or more second antenna port tables that are different from the one or more first antenna port tables when the transform precoder is disabled and when the number of transmission layers is greater than 4; and
referring to one or more third antenna port tables when the transform precoder is enabled.

32. The method of claim 1,
wherein the step of performing the uplink transmission comprises:
performing the uplink transmission comprising multiple Uplink Control Information (UCI) that are mapped to one or more codewords.

33. The method of claim 32, wherein a first UCI having a first UCI type priority is mapped to a first codeword, while a second UCI having a second UCI type priority is mapped to a second codeword that is different from the first codeword,
wherein the second UCI type priority is lower than the first UCI type priority.

34. The method of claim 33, wherein UCI type priorities of at least two of following are ordered from high to low in their listed order:
Hybrid automatic Repeat Request-Acknowledgement (HARQ-ACK),
Scheduling Request (SR),
Channel State Information (CSI) with a higher CSI priority, and
CSI with a lower CSI priority.

35. (canceled)

36. The method of claim 33, wherein one or more first transmission parameters are configured for a TB associated with the first codeword,
wherein one or more second transmission parameters are configured for a TB associated with the second codeword,
wherein at least one of the first transmission parameters has a first value that achieves a higher reliability than that achieved by a second value of a corresponding one of the second transmission parameters.

37. The method of claim 36, wherein the one or more transmission parameters comprise at least one of:
MCS; and
the number of transmission layers.

38-55. (canceled)

56. The method of claim 1, wherein the uplink transmission is performed with a repetition type A or a repetition Type B.

57. (canceled)

58. The method of claim 56, wherein at least one of repetitions of the uplink transmission carries the multiple codewords.

59. (canceled)

60. The method of claim 1, wherein the uplink transmission is Physical Uplink Shared Channel (PUSCH) transmission.

61. The method of claim 1, wherein the network node is a Transmission Reception Point (TRP).

62. A user equipment, comprising:
a processor;
a memory storing instructions which, when executed by the processor, cause the processor to perform, with one or more network nodes, an uplink transmission with multiple codewords.

63. A method at a network node for uplink transmission with multiple codewords from a UE, the method comprising:
performing, with the UE, an uplink transmission with multiple codewords.

64-127. (canceled)
